(19) United States
(12) Patent Application Publication
(10) Pub. No.: US 2022/0349848 A1
(43) Pub. Date: Nov. 3, 2022

(54) ANALYSIS DEVICE AND ANALYSIS METHOD

(71) Applicant: Keyence Corporation, Osaka (JP)

(72) Inventors: Hayato OHBA, Osaka (JP); Kenichiro HIROSE, Osaka (JP)

(73) Assignee: Keyence Corporation, Osaka (JP)

(21) Appl. No.: 17/688,968

(22) Filed: Mar. 8, 2022

(30) Foreign Application Priority Data
Apr. 30, 2021 (JP) 2021-077188

(51) Int. Cl. G01N 23/2251; G01N 23/223; G01N 23/2255

(52) U.S. Cl. CPC G01N 23/2251; G01N 23/223; G01N 23/2255; G01N 2223/076; G01N 2223/073; G01N 2223/418; G01N 2223/081; G01N 2223/306

(57) ABSTRACT

An analysis and observation device includes an analysis unit, a primary storage device that reads a substance library in which types of substances are associated with a plurality of characteristics, and a processor that executes processing based on the substance library. The substance library is configured by storing hierarchical information of superclasses each of which represents a general term of a substance and subclasses each of which represents a type of the substance. A processor includes: a spectrum acquirer that acquires an intensity distribution spectrum; a characteristic extractor that extracts a characteristic of a substance based on the intensity distribution spectrum; a substance estimator that estimates the type of the substance from subclasses based on the extracted characteristic; and a user interface controller that causes a display to display the estimated subclass and the superclass to which the subclass belongs in a hierarchical manner.

### CROSS-REFERENCE TO RELATED APPLICATIONS

The present application claims foreign priority based on Japanese Patent Application No. 2021-077188, filed Apr. 30, 2021, the contents of which are incorporated herein by reference.

### BACKGROUND OF THE INVENTION

### 1. Field of the Invention

The technique disclosed herein relates to an analysis device, an analysis method, an analysis program, and a storage medium storing the analysis program.

### 2. Description of Related Art

For example, WO 2017/006383 A discloses an analysis device (X-ray fluorescence analysis device) capable of performing X-ray fluorescence analysis (XRF).

Specifically, the analysis device disclosed in WO 2017/006383 A includes an X-ray tube that emits X-rays to an analyte (specimen) and a detector that detects X-rays from the analyte, and can generate and display a spectrum indicating a relationship between X-ray energy and an element content based on the X-rays detected by the detector.

However, an element contained in the analyte is approximately grasped, but it is not easy to intuitively grasp what kind of substance the analyte is only by displaying the spectrum as disclosed in WO 2017/006383 A.

### SUMMARY OF THE INVENTION

The technique disclosed herein has been made in view of such a point, and an object thereof is to allow a user to intuitively understand what kind of substance an analyte is.

According to one embodiment of the present disclosure, provided is an analysis device that emits a primary electromagnetic wave or a primary ray to an analyte to generate an intensity distribution spectrum, and performs component analysis of the analyte based on the intensity distribution spectrum. This analysis device includes: a storage section that reads a substance library in which a type of a substance is associated with a characteristic constituting the substance; and a processor that executes processing based on the substance library.

According to the one embodiment of the present disclosure, the substance library is configured by storing hierarchical information of a superclass representing a general term of the substance and subclasses representing types of a plurality of the substances belonging to the superclass, and the processor includes: a spectrum acquirer that acquires the intensity distribution spectrum; a characteristic extractor that extracts a characteristic included as a constituent component in the analyte based on the intensity distribution spectrum acquired by the spectrum acquirer; a substance estimator that estimates the type of the substance from the subclasses based on the characteristic extracted by the characteristic extractor and the substance library read by the storage section; and a user interface controller that causes a display to display the subclass estimated by the substance estimator and the superclass to which the subclass belongs in a hierarchical manner.

According to the one embodiment, since the subclass is displayed together with the superclass, not only a specific type of the substance can be grasped by the subclass, but also a general type, a property, a characteristic, and the like of the substance can be grasped by the superclass. As a result, a user can intuitively grasp what kind of substance the analyte is.

Further, according to another embodiment of the present disclosure, the substance estimator may estimate a plurality of substances each having a relatively high accuracy among substances that are likely to be contained in the analyte from the subclasses, and the user interface controller may cause the display to display the subclasses respectively corresponding to the plurality of substances arranged in descending order of the accuracy, an icon for switching between display and non-display of the subclass, and the superclass to which the subclass belongs.

According to the another embodiment, it is possible to provide an interface that can be operated more intuitively by using the icon. Further, the user can intuitively grasp any subclass to which a substance type belongs by arranging the subclasses in order of the accuracy.

Further, according to still another embodiment of the present disclosure, the substance library may be configured by storing hierarchical information of intermediate classes which represent a plurality of strains belonging to the superclass and to which at least some of the subclasses belong together with the hierarchical information of the superclass and the subclass, and the user interface controller may cause the display to display the intermediate class to which the subclass belongs and a second icon for switching between display and non-display of the intermediate class.

According to the still another embodiment, the substances can be classified more finely by preparing the intermediate class in addition to the superclass and the subclass. Further, the non-display of the intermediate class is performed by operating the second icon for users who do not want such detailed classification, and thus, it is possible to provide an interface that can be operated more intuitively and to improve the usability.

Further, according to still another embodiment of the present disclosure, the storage section may read, as the substance library, a first substance library created according to a first standard and a second substance library created according to a second standard, the substance estimator may estimate a plurality of substances each having a relatively high accuracy among substances that are likely to be contained in the analyte from the subclasses belonging to the first substance library and the subclasses belonging to the second substance library, and the user interface controller may cause the display to display the subclass estimated by the substance estimator together with identification information indicating any of the first substance library and the second substance library to which the subclass belongs to.

According to the still another embodiment, it is possible to provide a more flexible classification system and to meet a wide range of needs by preparing the plurality of substance libraries. Further, the user can easily grasp any substance library that has been used as a base of the classification system by causing the display to display the identification information. As a result, even when standards used as practices are different due to differences in industry or culture, it is possible to use a library suitable for a user and to meet a wide variety of needs.

Further, according to still another embodiment of the present disclosure, the storage section may read, as the substance library, a first substance library created according to a first standard and a user-defined substance library created based on an operation input of a user, the substance estimator may estimate a plurality of substances each having a relatively high accuracy among substances that are likely to be contained in the analyte from the subclasses belonging to the first substance library and the subclasses belonging to the user-defined substance library, and the user interface controller may cause the display to display the subclass estimated by the substance estimator together with identification information indicating any of the first substance library and the user-defined substance library to which the subclass belongs to.

According to the still another embodiment, it is possible to provide a more flexible classification system and to meet a wide range of needs by preparing the user-defined substance library in addition to a predetermined substance library. Further, the user can easily grasp whether or not the classification system is based on user defined substance library by causing the display to display the identification information. As a result, it is possible to help the user's intuitive understanding.

Further, according to still another embodiment of the present disclosure, the substance library may be configured by storing the superclass and a supplementary description related to the general term of the substance represented by the superclass in association with each other, and the user interface controller may receive selection of one of the superclasses displayed on the display and cause the display to display the supplementary description associated with the selected superclass.

According to the still another embodiment, the user can grasp the information related to the superclass such as the general type, the property, and the characteristic of the substance by causing the display to display the supplementary description associated with the selected superclass. As a result, there is an advantage in terms of allowing the user to grasp what kind of substance the analyte is.

Further, according to still another embodiment of the present disclosure, the user interface controller may receive selection of one of the subclasses displayed on the display, and cause the display to display the supplementary description associated with the superclass to which the selected subclass belongs.

According to the still another embodiment, the user can grasp the information related to the superclass such as the general type, the property, and the characteristic of the substance by causing the display to display the supplementary description associated with the superclass to which the selected subclass belongs. As a result, there is an advantage in terms of allowing the user to grasp what kind of substance the analyte is.

Further, according to still another embodiment of the present disclosure, the analysis device may further include: an emitter that emits a primary electromagnetic wave or a primary ray to the analyte; and a detector that receives a secondary electromagnetic wave generated in the analyte when the analyte is irradiated with the primary electromagnetic wave or the primary ray and generates an intensity distribution spectrum which is an intensity distribution for each wavelength of the secondary electromagnetic wave, and the spectrum acquirer may acquire the intensity distribution spectrum generated by the detector.

Further, according to still another embodiment of the present disclosure, the characteristic extractor may extract, as the characteristic of the substance, a type of an element contained in the substance and a content rate of the element.

Further, according to still another embodiment of the present disclosure, the characteristic extractor may extract as the characteristic of the substance, a molecular structure in the substance.

According to one embodiment of the present disclosure, provided is an analysis method for generating an intensity distribution spectrum by emitting a primary electromagnetic wave or a primary ray to an analyte and performing component analysis of the analyte based on the intensity distribution spectrum using an analysis device including a storage section that stores information and a processor. This analysis method includes: a reading step of reading, by the storage section, a substance library in which each of types of substances is associated with a characteristic of the substance; and a processing step of executing, by the processor, processing based on the substance library.

Then, according to the one embodiment of the present disclosure, the substance library is configured by storing hierarchical information of superclasses each of which represents a general term of the substance and subclasses respectively representing types of a plurality of the substances belonging to the superclass, and the processing step includes: an acquisition step of acquiring the intensity distribution spectrum; an extraction step of extracting characteristics included in the analyte as constituent components of the analyte based on the intensity distribution spectrum acquired in the acquisition step; an estimation step of estimating the type of the substance from the subclasses based on the characteristic extracted in the extraction step and the substance library read in the reading step; and a display step of causing a display to display the subclass estimated in the estimation step and the superclass to which the subclass belongs in a hierarchical state.

According to the one embodiment, since the subclass is displayed together with the superclass, not only a specific type of the substance can be grasped by the subclass, but also the general type, the property, the characteristic, and the like of the substance can be grasped by the superclass. As a result, a user can intuitively grasp what kind of substance the analyte is.

According to one embodiment of the present disclosure, provided is an analysis program which, when executed by an analysis device including a storage section that stores information and a processor, generates an intensity distribution spectrum by emitting a primary electromagnetic wave or a primary ray to an analyte and performs component analysis of the analyte based on the intensity distribution spectrum. This analysis program causes the analysis device to execute: a reading step of reading, by the storage section, a substance library in which each of types of substances is associated with a characteristic of the substance; and a processing step of executing, by the processor, processing based on the substance library.

Then, according to the one embodiment of the present disclosure, the substance library is configured by storing hierarchical information of superclasses each of which represents a general term of the substance and subclasses respectively representing types of a plurality of the substances belonging to the superclass, and the processing step causes the analysis device to execute: an acquisition step of acquiring the intensity distribution spectrum; an extraction step of extracting characteristics included in the analyte as constituent components of the analyte based on the intensity distribution spectrum acquired in the acquisition step; an estimation step of estimating the type of the substance from the subclasses based on the characteristic extracted in the extraction step and the substance library read in the reading step; and a display step of causing a display to display the subclass estimated in the estimation step and the superclass to which the subclass belongs in a hierarchical state.

According to the one embodiment, since the subclass is displayed together with the superclass, not only a specific type of the substance can be grasped by the subclass, but also the general type, the property, the characteristic, and the like of the substance can be grasped by the superclass. As a result, a user can intuitively grasp what kind of substance the analyte is.

Further according to one embodiment of the present disclosure, provided is a computer-readable storage medium. This storage medium stores the analysis program according to the one embodiment.

As described above, according to the present disclosure, the user can intuitively grasp what kind of substance the analyte is.

### BRIEF DESCRIPTION OF THE DRAWINGS

FIG. 1 is a schematic diagram illustrating an overall configuration of an analysis and observation device;

FIG. 2 is a perspective view illustrating an optical system assembly;

FIG. 3 is a side view illustrating the optical system assembly;

FIG. 4 is a front view illustrating the optical system assembly;

FIG. 5 is an exploded perspective view illustrating the optical system assembly;

FIG. 6 is a side view schematically illustrating a configuration of the optical system assembly;

FIG. 7 is a schematic view illustrating a configuration of an analysis optical system;

FIG. 8 is a schematic view for describing a configuration of a slide mechanism;

FIG. 9A is a view for describing horizontal movement of a head;

FIG. 9B is a view for describing the horizontal movement of the head;

FIG. 10A is a view for describing an operation of a tilting mechanism;

FIG. 10B is a view for describing the operation of the tilting mechanism;

FIG. 11 is a block diagram illustrating a configuration of a controller main body 2;

FIG. 12 is a block diagram illustrating a configuration of a controller;

FIG. 13A is a view for describing a basic concept of an analysis method;

FIG. 13B is a view for describing the basic concept of the analysis method;

FIG. 14 is a flowchart illustrating a basic operation of the analysis and observation device;

FIG. 15 is a flowchart illustrating a sample analysis procedure by the controller;

FIG. 16A is a view illustrating a display screen of a display;

FIG. 16B is a view illustrating the display screen of the display;

FIG. 16C is a view illustrating the display screen of the display;

FIG. 16D is a view illustrating the display screen of the display;

FIG. 16E is a view illustrating the display screen of the display;

FIG. 16F is a view illustrating the display screen of the display;

FIG. 16G is a view illustrating the display screen of the display; and

FIG. 16H is a view illustrating the display screen of the display.

### DETAILED DESCRIPTION OF PREFERRED EMBODIMENTS

Hereinafter, an embodiment of the present disclosure will be described with reference to the drawings. Note that the following description is given as an example.

<Overall Configuration of Analysis and Observation Device A>

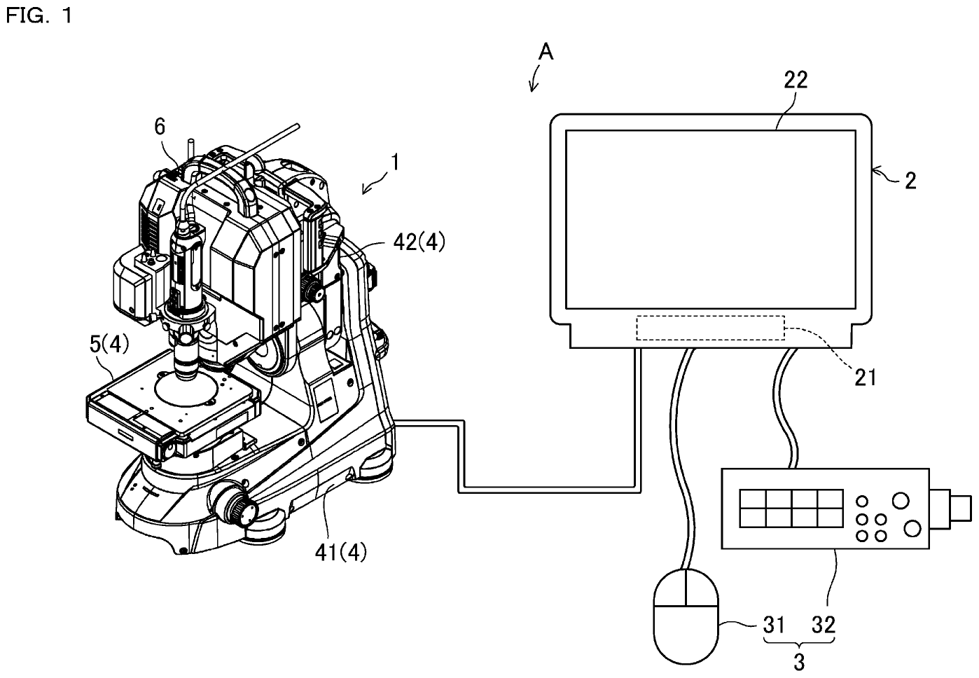

FIG. 1 is a schematic diagram illustrating an overall configuration of an analysis and observation device A as an analysis device according to an embodiment of the present disclosure. The analysis and observation device A illustrated in FIG. 1 can perform magnifying observation of a sample SP, which serves as both of an observation target and an analyte, and can also perform component analysis of the sample SP.

Specifically, for example, the analysis and observation device A according to the present embodiment can search for a site where component analysis is to be performed in the sample SP and perform inspection, measurement, and the like of an appearance of the site by magnifying and capturing an image of the sample SP including a specimen such as a micro object, an electronic component, a workpiece, and the like. When focusing on an observation function, the analysis and observation device A can be referred to as a magnifying observation device, simply as a microscope, or as a digital microscope.

The analysis and observation device A can also perform a method referred to as a laser induced breakdown spectroscopy (LIBS), laser induced plasma spectroscopy (LIPS), or the like in the component analysis of the sample SP. When focusing on an analysis function, the analysis and observation device A can be referred to as a component analysis device, simply as an analysis device, or as a spectroscopic device.

Note that the analysis and observation device A according to the present embodiment is not limited to the analysis device using the LIBS method. The analysis and observation device A may be configured as an analysis device using an analysis method (hereinafter, “SEM/EDX”) by energy dispersive X-ray spectroscopy (EDX) that uses an electron beam obtained by a scanning electron microscope (SEM), Raman spectroscopy, infrared spectroscopy, and ultraviolet-visible near-infrared spectroscopy (UV-Vis-NIR). Among these, the infrared spectroscopy includes at least Fourier transform infrared spectroscopy and photothermal conversion infrared spectroscopy.

Here, for example, the sample SP is mainly an inorganic substance in the case of using the LIBS method, and the sample SP is mainly an organic substance in the case of using the infrared spectroscopy or the like.

As illustrated in FIG. 1, the analysis and observation device A according to the present embodiment includes an optical system assembly (optical system main body) 1, a controller main body 2, and an operation section 3 as main constituent elements.

Among them, the optical system assembly 1 can perform capturing and analysis of the sample SP and output an electrical signal corresponding to a capturing result and an analysis result to the outside.

The controller main body 2 includes a controller 21 configured to control various components constituting the optical system assembly 1 such as a first camera 81. The controller main body 2 can cause the optical system assembly 1 to observe and analyze the sample SP using the controller 21. The controller main body 2 also includes a display 22 capable of displaying various types of information. The display 22 can display an image captured in the optical system assembly 1, data indicating the analysis result of the sample SP, and the like.

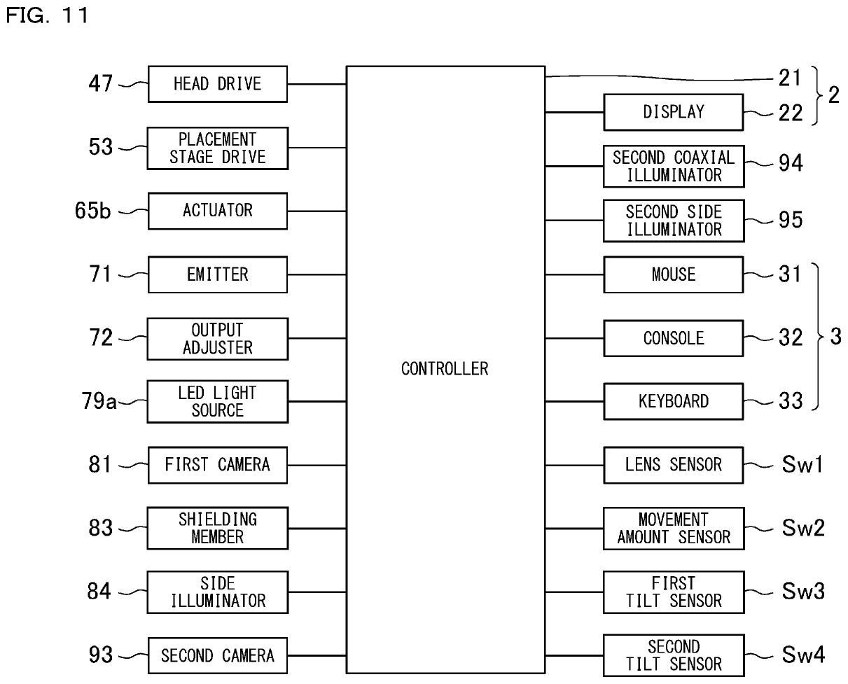

The operation section 3 includes a mouse 31, a console 32, and a keyboard 33 that receive an operation input by a user (the keyboard 33 is illustrated only in FIG. 11). The console 32 can instruct acquisition of image data, brightness adjustment, and focusing of the first camera 81 to the controller main body 2 by operating a button, an adjustment knob, and the like.

Note that the operation section 3 does not necessarily include all three of the mouse 31, the console 32, and the keyboard 33, and may include any one or two. Further, a touch-panel-type input device, an audio-type input device, or the like may be used in addition to or instead of the mouse 31, the console 32, and the keyboard 33. In the case of the touch-panel-type input device, any position on a screen displayed on the display 22 can be detected.

<Details of Optical System Assembly 1>

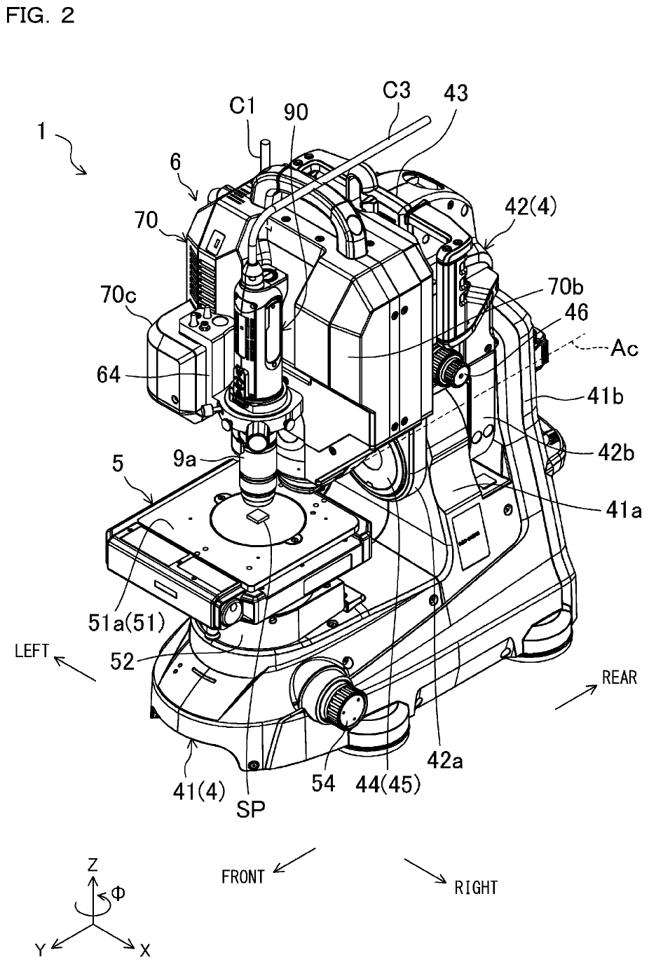

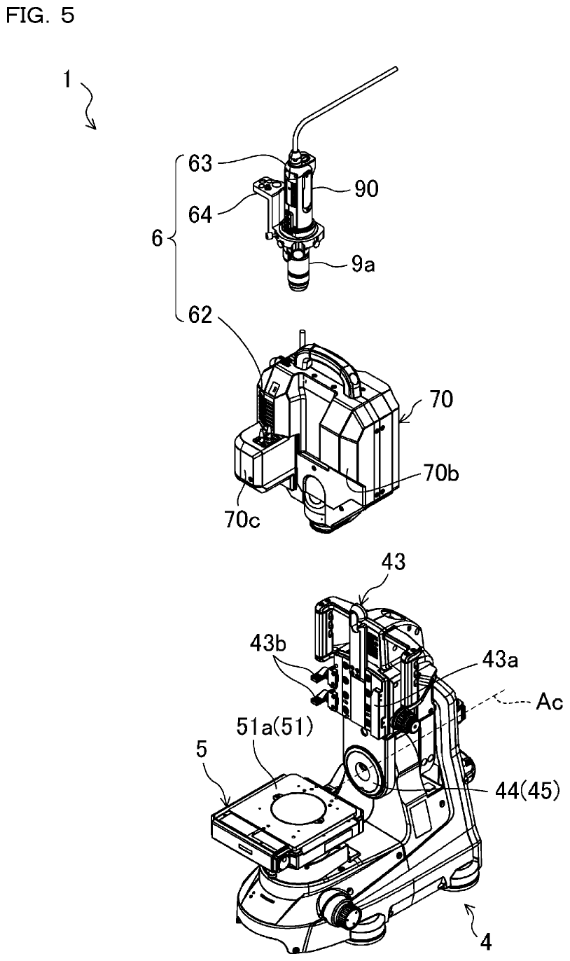

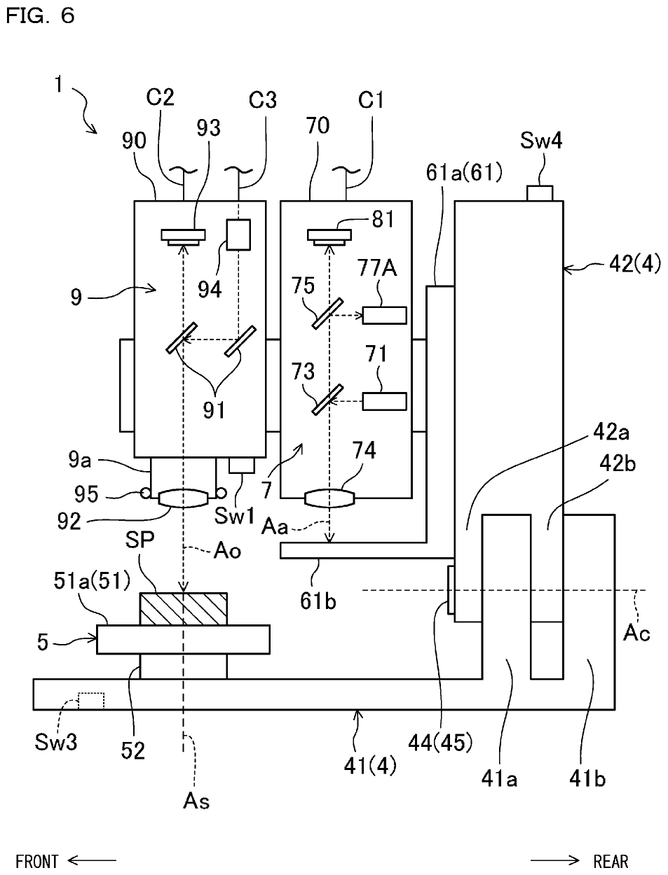

FIGS. 2 to 4 are a perspective view, a side view, and a front view respectively illustrating the optical system assembly 1. Further, FIG. 5 is an exploded perspective view of the optical system assembly 1, and FIG. 6 is a side view schematically illustrating a configuration of the optical system assembly 1.

As illustrated in FIGS. 1 to 6, the optical system assembly 1 includes: a stage 4 which supports various instruments and on which the sample SP is placed; and a head 6 attached to the stage 4. Here, the head 6 is formed by mounting an observation housing 90 in which an observation optical system 9 is accommodated onto an analysis housing 70 in which an analysis optical system 7 is accommodated. Here, the analysis optical system 7 is an optical system configured to perform the component analysis of the sample SP. The observation optical system 9 is an optical system configured to perform the magnifying observation of the sample SP. The head 6 is configured as a device group having both of an analysis function and a magnifying observation function of the sample SP.

Note that the front-rear direction and the left-right direction of the optical system assembly 1 are defined as illustrated in FIGS. 1 to 4 in the following description. That is, one side opposing the user is a front side of the optical system assembly 1, and an opposite side thereof is a rear side of the optical system assembly 1. When the user opposes the optical system assembly 1, a right side as viewed from the user is a right side of the optical system assembly 1, and a left side as viewed from the user is a left side of the optical system assembly 1. Note that the definitions of the front-rear direction and the left-right direction are intended to help understanding of the description, and do not limit an actual use state. Any direction may be used as the front.

Further, in the following description, the left-right direction of the optical system assembly 1 is defined as an “X direction”, the front-rear direction of the optical system assembly 1 is defined as a “Y direction”, a vertical direction of the optical system assembly 1 is defined as a “Z direction”, and a direction rotating about an axis parallel to the Z axis is defined as a “φ direction”. The X direction and the Y direction are orthogonal to each other on the same horizontal plane, and a direction along the horizontal plane is defined as a “horizontal direction”. The Z axis is a direction of a normal line orthogonal to the horizontal plane. These definitions can also be changed as appropriate.

The head 6 can move along a central axis Ac illustrated in FIGS. 2 to 6 or swing about the central axis Ac although will be described in detail later. As illustrated in FIG. 6 and the like, the central axis Ac extends along the above-described horizontal direction, particularly the front-rear direction.

(Stage 4)

The stage 4 includes a base 41 set on a workbench or the like, a stand 42 connected to the base 41, and a placement stage 5 supported by the base 41 or the stand 42. The stage 4 is a member configured to define a relative positional relation between the placement stage 5 and the head 6, and is configured such that at least the observation optical system 9 and the analysis optical system 7 of the head 6 are attachable thereto.

The base 41 forms a substantially lower half of the stage 4, and is formed in a pedestal shape such that a dimension in the front-rear direction is longer than a dimension in the left-right direction as illustrated in FIG. 2. The base 41 has a bottom surface to be installed on the workbench or the like. The placement stage 5 is attached to a front portion of the base 41.

Further, a first supporter 41a and a second supporter 41b are provided in a state of being arranged side by side in order from the front side on the rear side portion (in particular, a portion located on the rear side of the placement stage 5) of the base 41 as illustrated in FIG. 6 and the like. Both the first and second supporters 41a and 41b are provided so as to protrude upward from the base 41. Circular bearing holes (not illustrated) arranged to be concentric with the central axis Ac are formed in the first and second supporters 41a and 41b.

The stand 42 forms an upper half of the stage 4, and is formed in a columnar shape extending in the vertical direction perpendicular to the base 41 (particularly, the bottom surface of the base 41) as illustrated in FIGS. 2 and 3, 6, and the like. The head 6 is attached to a front surface of an upper portion of the stand 42 via a separate mounting tool 43.

Further, a first attachment section 42a and a second attachment section 42b are provided in a lower portion of the stand 42 in a state of being arranged side by side in order from the front side as illustrated in FIG. 6 and the like. The first and second attachment sections 42a and 42b have configurations corresponding to the first and second supporters 41a and 41b, respectively. Specifically, the first and second supporters 41a and 41b and the first and second attachment sections 42a and 42b are laid out such that the first supporter 41a is sandwiched between the first attachment section 42a and the second attachment section 42b and the second attachment section 42b is sandwiched between the first supporter 41a and the second supporter 41b.

Further, circular bearing holes (not illustrated) concentric with and having the same diameter as the bearing holes formed in the first and second attachment sections 42a and 42b are formed in the first and second supporters 41a and 41b. A shaft member 44 is inserted into these bearing holes via a bearing (not illustrated) such as a cross-roller bearing. The shaft member 44 is arranged such that the axis thereof is concentric with the central axis Ac. The base 41 and the stand 42 are coupled so as to be relatively swingable by inserting the shaft member 44. The shaft member 44 forms a tilting mechanism 45 in the present embodiment together with the first and second supporters 41a and 41b and the first and second attachment sections 42a and 42b.

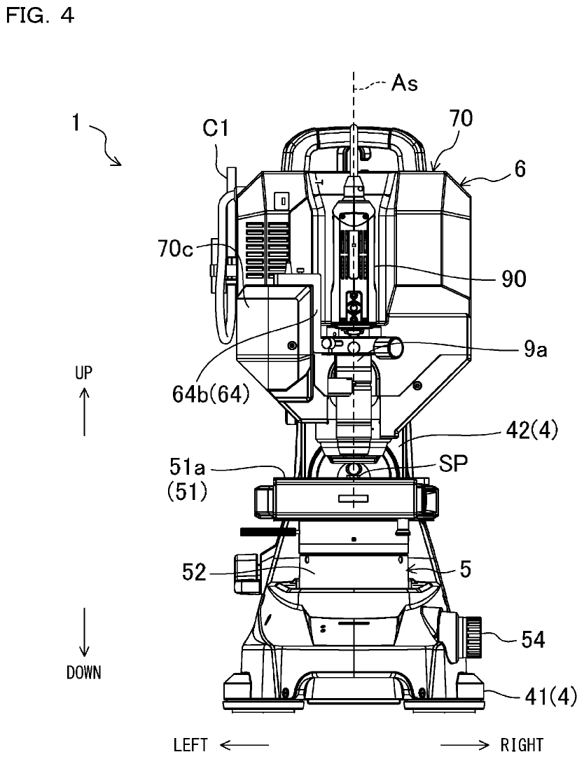

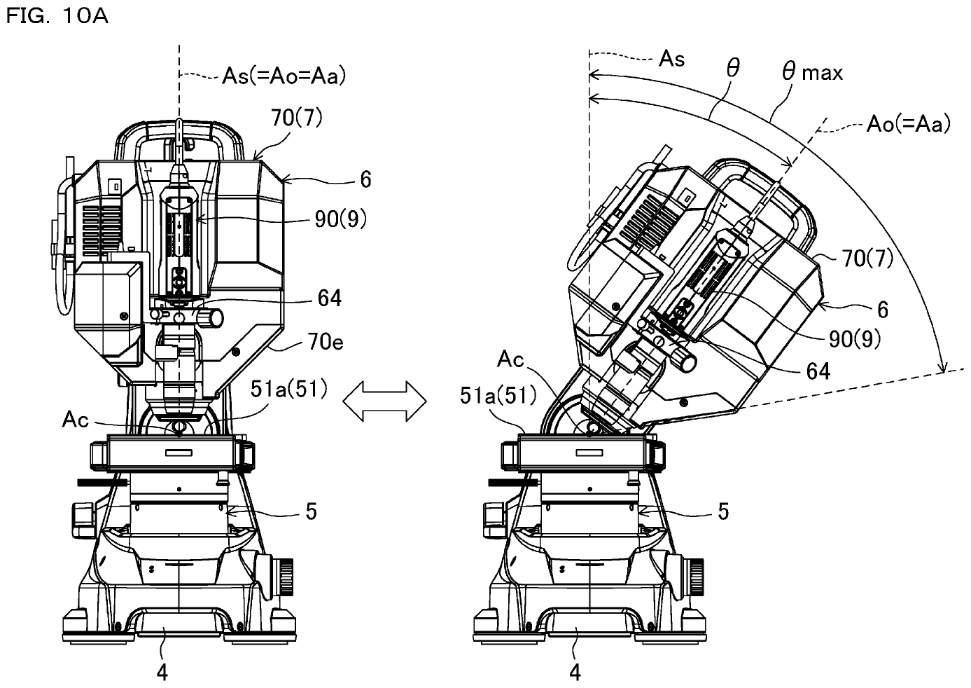

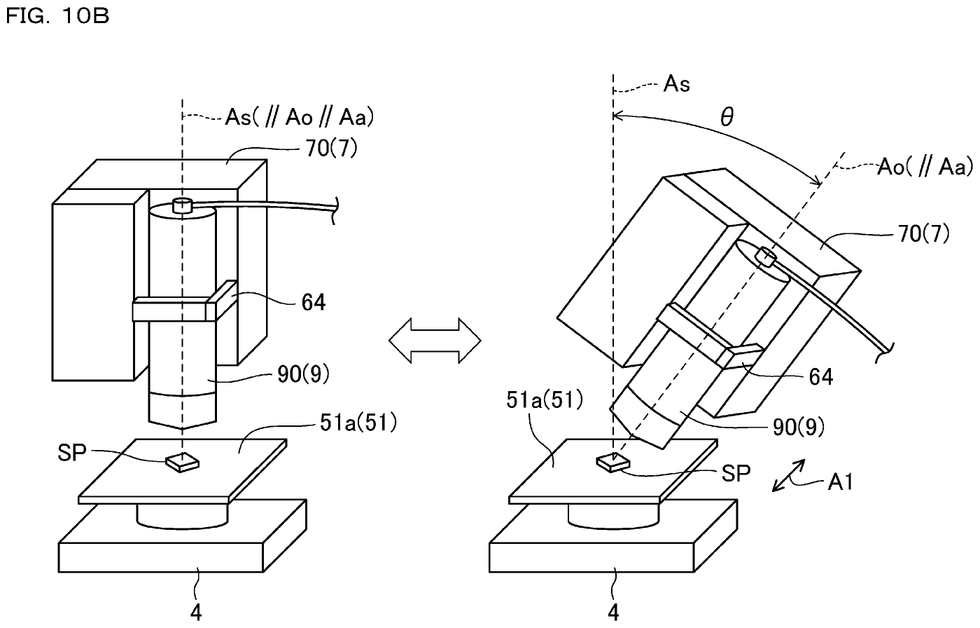

As the base 41 and the stand 42 are coupled via the tilting mechanism 45, the stand 42 is supported by the base 41 in the state of being swingable about the central axis Ac. The stand 42 swings about the central axis Ac to be tilted in the left-right direction with respect to a predetermined reference axis As (see FIGS. 10A and 10B). The reference axis As can be set as an axis extending perpendicularly to an upper surface (placement surface 51a) of the placement stage 5 in a non-tilted state illustrated in FIG. 4 and the like. Further, the central axis Ac functions as a central axis (rotation center) of swing caused by the tilting mechanism 45.

Specifically, the tilting mechanism 45 according to the present embodiment can tilt the stand 42 rightward by about 90° with respect to the reference axis As or leftward by about 60° with respect to the reference axis As. Since the head 6 is attached to the stand 42 as described above, the head 6 can also be tilted in the left-right direction with respect to the reference axis As. Tilting the head 6 is equivalent to tilting the analysis optical system 7 and the observation optical system 9, and eventually, tilting an analysis optical axis Aa and an observation optical axis Ao which will be described later.

The mounting tool 43 has a rail 43a that guides the head 6 along a longitudinal direction of the stand 42, and a lock lever 43b configured to locking a relative position of the head 6 with respect to the rail 43a. Here, the longitudinal direction of the stand 42 coincides with the vertical direction (first direction) in the non-tilted state, and also coincides with a direction extending along the analysis optical axis Aa, the observation optical axis Ao, and the reference axis As. The longitudinal direction of the stand 42 does not match the vertical direction and the direction extending along the reference axis As in the tilted state, but still coincides with the direction extending along the analysis optical axis Aa and the observation optical axis Ao. The longitudinal direction of the stand 42 is also referred to as a “substantially vertical direction” in the following description.

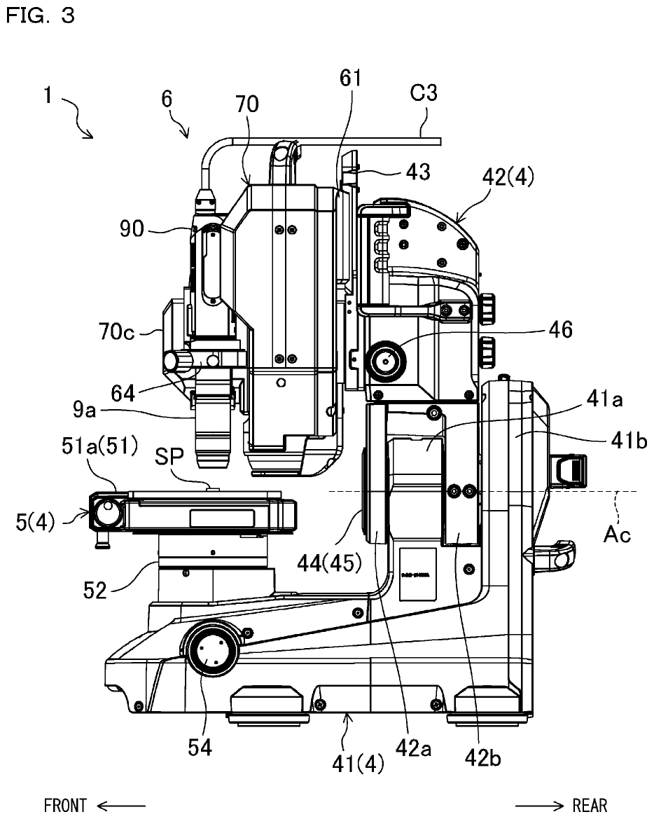

A rear surface portion (specifically, a head attachment member 61) of the head 6 is inserted into the rail 43a. The rail 43a can move the rear surface portion in the substantially vertical direction. Then, the head 6 can be fixed at a desired position by operating the lock lever 43b in a state where the head 6 is set at a desired position. Further, the position of the head 6 can also be adjusted by operating a first operation dial 46 illustrated in FIGS. 2 to 3.

Further, the stage 4 or the head 6 incorporates a head drive 47 configured to move the head 6 in the substantially vertical direction. The head drive 47 includes an actuator (for example, a stepping motor) (not illustrated) controlled by the controller main body 2 and a motion conversion mechanism that converts the rotation of an output shaft of the stepping motor into a linear motion in the substantially vertical direction, and moves the head 6 based on a drive pulse input from the controller main body 2. When the head drive 47 moves the head 6, the head 6, and eventually, the analysis optical axis Aa and the observation optical axis Ao can be moved along the substantially vertical direction.

The placement stage 5 is arranged on the front side of the center of the base 41 in the front-rear direction, and is attached to an upper surface of the base 41. The placement stage 5 is configured as an electric placement stage, and can cause the sample SP placed on the placement surface 51a to move along the horizontal direction, to move up and down along the vertical direction, or to rotate along the φ direction.

Specifically, as illustrated in FIGS. 2 to 4, the placement stage 5 according to the present embodiment includes: a placement stage main body 51 having the placement surface 51a configured for mounting of the sample SP; a placement stage supporter 52 that is arranged between the base 41 and the placement stage main body 51 and displaces the placement stage main body 51; and a placement stage drive 53 illustrated in FIG. 11 which will be described later.

The placement stage main body 51 is configured as a so-called XY stage. An upper surface of the placement stage main body 51 forms the placement surface 51a on which the sample SP is placed. The placement surface 51a is formed to extend along the substantially horizontal direction. The sample SP is placed on the placement surface 51a in an atmospheric open state, that is, in a state of not being accommodated in a vacuum chamber or the like.

The placement stage supporter 52 is a member that couples the base 41 and the placement stage main body 51, and is formed in a substantially columnar shape extending along the vertical direction. The placement stage supporter 52 can accommodate the placement stage drive 53.

The placement stage drive 53 includes a plurality of actuators (for example, stepping motors) (not illustrated) controlled by the controller main body 2 and a motion conversion mechanism that converts the rotation of an output shaft of each stepping motor into a linear motion, and moves the placement stage main body 51 based on a drive pulse input from the controller main body 2. As the placement stage main body 51 is moved by the placement stage drive 53, the placement stage main body 51, and eventually, the sample SP placed on the placement surface 51a can be moved along the horizontal direction and the vertical direction.

Similarly, the placement stage drive 53 can also rotate the placement stage main body 51 about a predetermined rotation axis along the φ direction based on a drive pulse input from the controller main body 2. As the placement stage drive 53 rotates the placement stage main body 51, the sample SP placed on the placement surface 51a can be rotated in the φ direction. Note that the configuration including the placement stage drive 53 is not essential. The placement stage main body 51 may be configured to be manually rotated.

In particular, the placement surface 51a according to the present embodiment is configured to be rotatable about the reference axis As illustrated in FIG. 6 or the like as the rotation axis. That is, the reference axis As, which is a reference of tilting, and the rotation axis of the placement surface 51a are set to be coaxial in the present embodiment.

Further, the placement stage main body 51 can be manually moved and rotated by operating a second operation dial 54 or the like illustrated in FIG. 2. Details of the second operation dial 54 are omitted.

Returning to the description of the base 41 and the stand 42, a first tilt sensor Sw3 is incorporated in the base 41. The first tilt sensor Sw3 can detect a tilt of the reference axis As perpendicular to the placement surface 51a with respect to the direction of gravity. On the other hand, a second tilt sensor Sw4 is attached to the stand 42. The second tilt sensor Sw4 can detect a tilt of the analysis optical system 7 with respect to the direction of gravity (more specifically, a tilt of the analysis optical axis Aa with respect to the direction of gravity). Detection signals of the first tilt sensor Sw3 and the second tilt sensor Sw4 are both input to the controller 21.

(Head 6)

The head 6 includes the head attachment member 61, an analysis unit 62 in which the analysis optical system 7 is accommodated in the analysis housing 70, an observation unit 63 in which the observation optical system 9 is accommodated in the observation housing 90, a housing coupler 64, and a slide mechanism (horizontal drive mechanism) 65 (the analysis unit 62 and the observation unit 63 are illustrated only in FIG. 5). The head attachment member 61 is a member configured to connect the analysis housing 70 to the stand 42. The analysis unit 62 is a device configured to perform the component analysis of the sample SP by the analysis optical system 7. The observation unit 63 is a device configured to perform the observation of the sample SP by the observation optical system 9. The housing coupler 64 is a member configured to connect the observation housing 90 to the analysis housing 70. The slide mechanism 65 is a mechanism configured to slide the analysis housing 70 with respect to the stand 42.

Specifically, the head attachment member 61 according to the present embodiment is arranged on the rear side of the head 6, and is configured as a plate-like member for mounting the head 6 to the stand 42. As described above, the head attachment member 61 is fixed to the mounting tool 43 of the stand 42.

The head attachment member 61 includes: a plate main body 61a extending substantially parallel to a rear surface of the head 6; and a cover member 61b protruding forward from a lower end of the plate main body 61a. The plate main body 61a is separated from the rear surface of the head 6 in the front-rear direction in a first mode to be described later in which the reflective object lens 74 faces the sample SP. The plate main body 61a is in close contact with or in proximity to the rear surface of the head 6 in a second mode to be described later in which the objective lens 92 faces the sample SP.

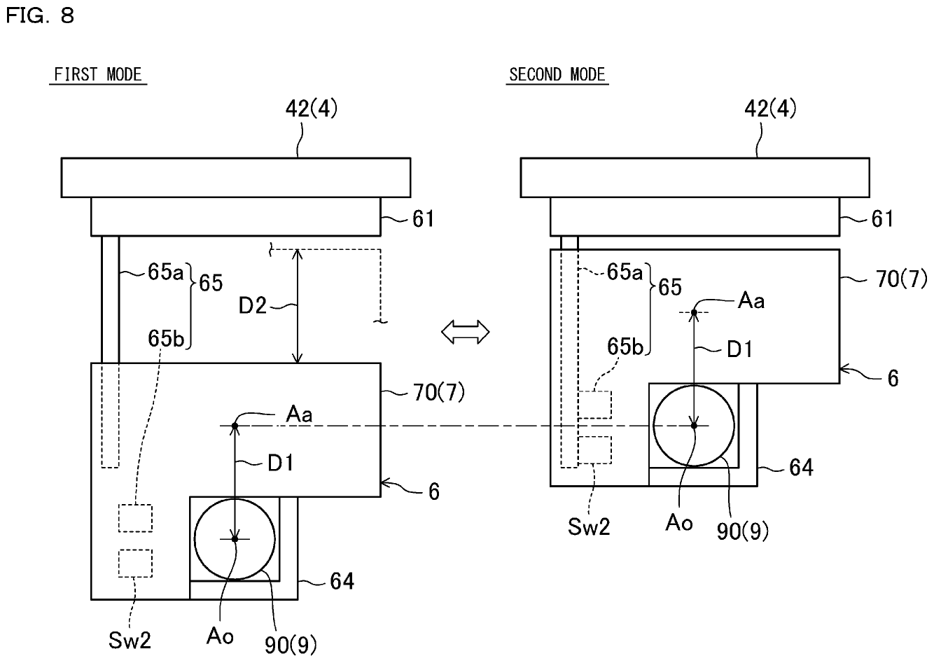

Further, a guide rail 65a forming the slide mechanism 65 is attached to a left end of the head attachment member 61 as illustrated in FIG. 8. The guide rail 65a couples the head attachment member 61 and other elements (specifically, the analysis optical system 7, the observation optical system 9, and the housing coupler 64) in the head 6 so as to be relatively displaceable in the horizontal direction.

Hereinafter, the configurations of the analysis unit 62, the observation unit 63, the housing coupler 64, and the slide mechanism 65 will be sequentially described.

-Analysis Unit 62-

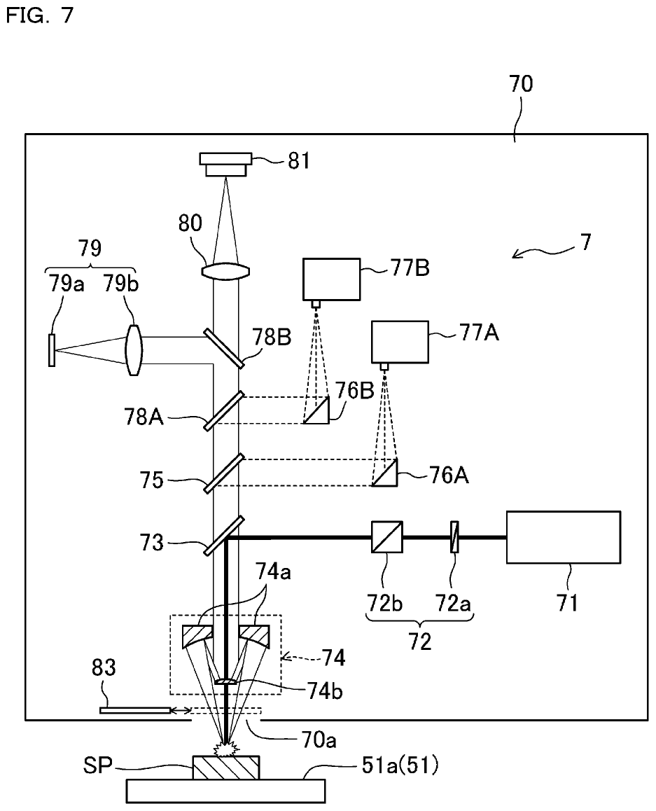

FIG. 7 is a schematic view illustrating the configuration of the analysis optical system 7.

The analysis unit 62 includes the analysis optical system 7 and the analysis housing 70 in which the analysis optical system 7 is accommodated. The analysis optical system 7 is a set of components configured to analyze the sample SP as an analyte, and the respective components are accommodated in the analysis housing 70. Further, elements configured to analyze the sample SP also include the controller 21 of the controller main body 2.

The analysis optical system 7 can perform analysis using, for example, an LIBS method. A communication cable C1, configured to transmit and receive an electrical signal to and from the controller main body 2, is connected to the analysis optical system 7. The communication cable C1 is not essential, and the analysis optical system 7 and the controller main body 2 may be connected by wireless communication.

Note that the term “optical system” used herein is used in a broad sense. That is, the analysis optical system 7 is defined as a system including a light source, an image capturing element, and the like in addition to an optical element such as a lens. The same applies to the observation optical system 9.

As illustrated in FIG. 7, the analysis optical system 7 according to the present embodiment includes the emitter 71, an output adjuster 72, the deflection element 73, the reflective object lens 74, a dispersing element 75, a first parabolic mirror 76A, the first detector 77A, a first beam splitter 78A, a second parabolic mirror 76B, the second detector 77B, a second beam splitter 78B, a coaxial illuminator 79, an imaging lens 80, a first camera 81, and the side illuminator 84. Some of the constituent elements of the analysis optical system 7 are also illustrated in FIG. 6. Further, the side illuminator 84 is illustrated only in FIG. 11.

Note that these components are useful in the analysis and observation device A using the LIBS method, but depending on analysis methods, the reflective object lens 74 or the like is not required, and only some of the constituent elements are required. It is sufficient for the analysis and observation device A to include the emitter 71 and at least one of the first and second detectors 77A and 77B.

The emitter 71 emits a primary electromagnetic wave or a primary ray to the sample SP. In particular, the emitter 71 according to the present embodiment includes a laser light source that emits laser light as the primary electromagnetic wave.

Although not illustrated in detail, the emitter 71 according to the present embodiment includes: an excitation light source configured using a laser diode (LD) or the like; a focusing lens that collects laser output from the excitation light source and emits the laser as laser excitation light; a laser medium that generates a fundamental wave based on the laser excitation light; a Q switch configured to pulse-oscillate the fundamental wave; a rear mirror and an output mirror configured for resonation of the fundamental wave; and a wavelength conversion element that converts a wavelength of laser light output from the output mirror.

Here, as the laser medium, for example, rod-shaped Nd:YAG is preferably used in order to obtain high energy per pulse. Note that, in the present embodiment, a wavelength (so-called fundamental wavelength) of photons emitted from the laser medium by stimulated emission is set to 1064 nm in the infrared range in the present embodiment.

Further, as the Q switch, a passive Q switch in which a transmittance increases when an intensity of the fundamental wave exceeds a predetermined threshold can be used. The passive Q switch is configured using, for example, a supersaturated absorber such as Cr:YAG. Since the passive Q switch is used, it is possible to automatically perform pulse oscillation at a timing when a predetermined amount of energy or more is accumulated in the laser medium. Further, a so-called active Q switch capable of externally controlling an attenuation rate can also be used.

Further, two nonlinear optical crystals, such as LBO (LiB₃O₃), are used as the wavelength conversion element. Since two crystals are used, a third harmonic wave can be generated from the fundamental wave. A wavelength of the third harmonic wave is set to 355 nm in the ultraviolet region in the present embodiment.

That is, the emitter 71 according to the present embodiment can output the laser light formed of ultraviolet rays as the primary electromagnetic wave. As a result, it is possible to optically analyze the transparent sample SP like glass by the LIBS method. Further, the proportion of laser light in the ultraviolet range reaching a human retina is extremely small. The safety of the device can be enhanced by adopting the configuration in which the laser light does not form an image on the retina.

Note that an electromagnetic wave other than the laser light can be used as the primary electromagnetic wave depending on a type of analysis method in the case of the analysis and observation device A using the analysis method other than the LIBS method. For example, in the case of using the Raman spectroscopy, predetermined monochromatic light can be used as the primary electromagnetic wave. Further, infrared light can be used as the primary electromagnetic wave in the case of using the infrared spectroscopy, and an electromagnetic wave belonging to ultraviolet light, visible light, and near-red light can be used as the primary electromagnetic wave in the case of using the ultraviolet-visible near-infrared spectroscopy.

Note that, instead of the primary electromagnetic wave, a primary ray formed of a radiation ray can be also emitted from the emitter 71 depending on a type of analysis method. Further, in the case of the analysis and observation device A using the SEM/EDX method or an X-ray fluorescence analysis method, the emitter 71 emits an X-ray, an electron beam, a charged particle, and the like as the primary ray. Furthermore, in the case of the analysis and observation device A using a mass spectrometry method, the emitter 71 emits an electron beam, a neutral atom, a laser beam, an ionized gas, and a plasma gas.

The output adjuster 72 is arranged on an optical path connecting the emitter 71 and the deflection element 73, and can adjust an output of the laser light (primary electromagnetic wave). Specifically, the output adjuster 72 according to the present embodiment includes a half-wave plate 72a and a polarization beam splitter 72b. The half-wave plate 72a is configured to rotate relative to the polarization beam splitter 72b, and the amount of light passing through the polarization beam splitter 72b can be adjusted by controlling a rotation angle thereof.

The laser light (primary electromagnetic wave) whose output has been adjusted by the output adjuster 72 is reflected by a mirror (not illustrated) and is incident on the deflection element 73.

Specifically, the deflection element 73 is laid out so as to reflect the laser light, which has been output from the emitter 71 and passed through the output adjuster 72, to be guided to the sample SP via the reflective object lens 74, and allow passage of light (which is light emitted due to plasma occurring on the surface of the sample SP, and is hereinafter referred to as “plasma light”) generated in the sample SP in response to the laser light and guide the secondary electromagnetic wave to the first detector 77A and the second detector 77B. The deflection element 73 is also laid out to allow passage of visible light collected for capturing and guide most of the visible light to the first camera 81.

Ultraviolet laser light reflected by the deflection element 73 propagates along the analysis optical axis Aa as parallel light and reaches the reflective object lens 74.

The reflective object lens 74 is configured to collect the secondary electromagnetic wave generated in the sample SP as the sample SP is irradiated with the primary electromagnetic wave or primary ray emitted from the emitter 71. In particular, the reflective object lens 74 according to the present embodiment is configured to collect the laser light as the primary electromagnetic wave and irradiate the sample SP with the laser light, and collect the plasma light (secondary electromagnetic wave) generated in the sample SP in response to the laser light (primary electromagnetic wave) applied to the sample SP. In this case, the secondary electromagnetic wave corresponds to the plasma light emitted due to the plasma occurring on the surface of the sample SP.

The reflective object lens 74 is configured to make an optical system related to the emission of the primary electromagnetic wave from the emitter 71 coaxial with an optical system related to reception of the reflection light in the first camera 81 and reception of the secondary electromagnetic wave in the first and second detectors 77A and 77B. In other words, the reflective object lens 74 is shared by the two types of optical systems.

The reflective object lens 74 has the analysis optical axis Aa extending along the substantially vertical direction. The analysis optical axis Aa is provided to be parallel to the observation optical axis Ao of an objective lens 92 of the observation optical system 9.

Specifically, the reflective object lens 74 according to the present embodiment is a Schwarzschild objective lens including two mirrors. As illustrated in FIG. 7, the reflective object lens 74 includes primary mirror 74a having a partial annular shape and a relatively large diameter, and a secondary mirror 74b having a disk shape and a relatively small diameter.

The primary mirror 74a allows the laser light (primary electromagnetic wave) to pass through an opening provided at the center thereof, and reflects the plasma light (secondary electromagnetic wave) generated in the sample SP by a mirror surface provided in the periphery thereof. The latter plasma light is reflected again by a mirror surface of the secondary mirror 74b, and passes through the opening of the primary mirror 74a in a state of being coaxial with the laser light.

The secondary mirror 74b is configured to transmit the laser light having passed through the opening of the primary mirror 74a and collect and reflect the plasma light reflected by the primary mirror 74a. The former laser light is applied to the sample SP, but the latter plasma light passes through the opening of the primary mirror 74a and reaches the deflection element 73 as described above.

Therefore, when laser light is input to the reflective object lens 74, the laser light is transmitted through the secondary mirror 74b arranged at the center of the reflective object lens 74 and reaches the surface of the sample SP. When the sample SP is locally turned into plasma by the laser light reaching the sample SP so that plasma light is emitted, the plasma light passes through an opening provided around the secondary mirror 74b and reaches the primary mirror 74a. The plasma light that has reached the primary mirror 74a is reflected by the mirror surface to reach the secondary mirror 74b, and is reflected by the secondary mirror 74b again to reach the deflection element 73 from the reflective object lens 74. The reflection light having reached the deflection element 73 passes through the deflection element 73 and reaches the dispersing element 75.

Note that an electromagnetic wave other than the plasma light can be used as the secondary electromagnetic wave depending on a type of analysis method in the case of the analysis and observation device A using the analysis method other than the LIBS method. For example, in the case of using the Raman spectroscopy, Raman scattered light can be used as the secondary electromagnetic wave. Further, light reflected by the sample SP or light transmitted through the sample SP can be used as the secondary electromagnetic wave in the case of using the infrared spectroscopy, and an electromagnetic wave belonging to ultraviolet light, visible light, and near-red light can be used as the secondary electromagnetic wave in the case of using the ultraviolet-visible near-infrared spectroscopy.

Note that the secondary electromagnetic wave is not the electromagnetic wave generated in the sample SP but reflection light reflected by the sample SP in the case of using the Raman spectroscopy. In the case of using the Fourier transform infrared spectroscopy and the ultraviolet-visible near-infrared spectroscopy, the secondary electromagnetic wave is the primary electromagnetic wave transmitted through the sample SP or the primary electromagnetic wave reflected by the sample SP.

Further, even when the primary ray is emitted from the emitter 71 instead of the primary electromagnetic wave, various electromagnetic waves can be used as the secondary electromagnetic wave. Specifically, when the analysis and observation device A is configured using SEM/EDX, the first and second detectors 77A and 77B receive a characteristic X-ray as the secondary electromagnetic wave.

The dispersing element 75 is arranged between the deflection element 73 and the first beam splitter 78A in the optical axis direction (direction along the analysis optical axis Aa) of the reflective object lens 74, and guides a part of the plasma light generated in the sample SP to the first detector 77A and the other part to the second detector 77B or the like. Most of the latter plasma light is guided to the second detector 77B, but the rest reaches the first camera 81.

Specifically, the plasma light (secondary electromagnetic wave) returned from the sample SP includes various wavelength components in addition to a wavelength corresponding to the laser light as the primary electromagnetic wave. Therefore, the dispersing element 75 according to the present embodiment reflects an electromagnetic wave in a short wavelength band out of the secondary electromagnetic wave returning from the sample SP, and guides the electromagnetic wave to the first detector 77A. The dispersing element 75 also transmits electromagnetic waves in other bands and guides the electromagnetic waves to the second detector 77B and the like.

The first parabolic mirror 76A is a so-called parabolic mirror, and is arranged between the dispersing element 75 and the first detector 77A. The first parabolic mirror 76A collects the secondary electromagnetic wave reflected by the dispersing element 75, and causes the collected secondary electromagnetic wave to be incident on the first detector 77A.

The first detector 77A receives the secondary electromagnetic wave generated in the sample SP as the sample SP is irradiated with the primary electromagnetic wave or primary ray emitted from the emitter 71 and generates an intensity distribution spectrum which is an intensity distribution of the secondary electromagnetic wave for each wavelength.

In particular, in a case where the emitter 71 is configured using the laser light source and the reflective object lens 74 is configured to collect the plasma light as the secondary electromagnetic wave generated in response to the irradiation of laser light as the primary electromagnetic wave, the first detector 77A reflects light at different angles for each wavelength to separate the light, and causes each beam of the separated light to be incident on an imaging element having a plurality of pixels. As a result, a wavelength of light received by each pixel can be made different, and a light reception intensity can be acquired for each wavelength. In this case, the intensity distribution spectrum corresponds to an intensity distribution for each wavelength of light.

Note that the analysis and observation device A can also detect that the primary electromagnetic wave has been absorbed in the sample SP by irradiating the sample SP with the primary electromagnetic wave. At that time, the emitter 71 continuously irradiates the primary electromagnetic wave while changing the wavelength. The first and second detectors 77A and 77B as detectors can generate the intensity distribution spectrum based on the wavelength of the primary electromagnetic wave absorbed in the sample SP and the magnitude of thermal expansion caused by the absorption of the primary electromagnetic wave.

For example, in the case of using photothermal conversion infrared spectroscopy as the analysis method, the analysis and observation device A irradiates the sample SP with infrared light as the primary electromagnetic wave. The emitted infrared light is absorbed by the sample SP. The sample SP undergoes a temperature change due to the absorption of the primary electromagnetic wave, and undergoes thermal expansion in response to the temperature change. The analysis and observation device A can analyze a characteristic of the sample SP based on a relationship between the magnitude of the thermal expansion of the sample SP and a wavelength corresponding to the thermal expansion. That is, in the case of using the photothermal conversion infrared spectroscopy, the first and second detectors 77A and 77B as the detectors generate the intensity distribution spectrum representing the relationship between each of wavelengths of the infrared light emitted to the sample SP and the magnitude of the thermal expansion of the temperature change generated for each of the wavelengths.

Further, the analysis and observation device A can also detect the ionized sample SP by irradiating the sample SP with the primary electromagnetic wave or the primary ray. At that time, the emitter 71 irradiates an electron beam, a neutral atom, a laser beam, an ionized gas, and a plasma gas. The first and second detectors 77A and 77B can generate the intensity distribution spectrum based on m/z of the sample SP ionized by the primary electromagnetic wave or the primary ray (a dimensionless quantity obtained as a mass of ions is divided by unified atomic mass units and further divided by the number of charges of the ions) and the magnitude of a detection intensity for each m/z.

For example, in the case of using an electron ionization method (EI method) as the analysis method, the analysis and observation device A irradiates the sample SP with a thermal electron as the primary electromagnetic wave. The sample SP that has been irradiated with the thermal electron is ionized. The analysis and observation device A can analyze a characteristic of the sample SP based on a relationship between m/z of the ionized sample SP and its detection intensity.

Note that the intensity distribution spectrum may be configured using the light reception intensity acquired for each wave number. Since the wavelength and the wave number uniquely correspond to each other, the intensity distribution spectrum can be regarded as the intensity distribution for each wavelength even when the light reception intensity acquired for each wave number is used. The same applies to the second detector 77B which will be described later.

As the first detector 77A, for example, a detector based on a Czerny-Turner detector can be used. An entrance slit of the first detector 77A is aligned with a focal position of the first parabolic mirror 76A. The intensity distribution spectrum generated by the first detector 77A is input to the controller 21 of the controller main body 2.

The first beam splitter 78A reflects a part of light, transmitted through the dispersing element 75 (secondary electromagnetic wave on the infrared side including the visible light band), to be guided to the second detector 77B, and transmits the other part (a part of the visible light band) to be guided to the second beam splitter 78B. A relatively large amount of plasma light is guided to the second detector 77B out of plasma light belonging to the visible light band, and a relatively small amount of plasma light is guided to the first camera 81 via the second beam splitter 78B.

The second parabolic mirror 76B is a so-called parabolic mirror and is arranged between the first beam splitter 78A and the second detector 77B, which is similar to the first parabolic mirror 76A. The second parabolic mirror 76B collects a secondary electromagnetic wave reflected by the first beam splitter 78A, and causes the collected secondary electromagnetic wave to be incident on the second detector 77B.

The second detector 77B receives the secondary electromagnetic wave generated in the sample SP as the sample SP is irradiated with the primary electromagnetic wave or primary ray emitted from the emitter 71 and generates an intensity distribution spectrum which is an intensity distribution of the secondary electromagnetic wave for each wavelength, which is similar to the first detector 77A.

In particular, in a case where the emitter 71 is configured using the laser light source and the reflective object lens 74 is configured to collect the plasma light as the secondary electromagnetic wave generated in response to the irradiation of laser light as the primary electromagnetic wave, the second detector 77B reflects light at different angles for each wavelength to separate the light, and causes each beam of the separated light to be incident on an imaging element having a plurality of pixels. As a result, a wavelength of light received by each pixel can be made different, and a light reception intensity can be acquired for each wavelength. In this case, the intensity distribution spectrum corresponds to an intensity distribution for each wavelength of light.

As the second detector 77B, for example, a detector based on a Czerny-Turner detector can be used. An entrance slit of the second detector 77B is aligned with a focal position of the first parabolic mirror 76A. The intensity distribution spectrum generated by the second detector 77B is input to the controller 21 of the controller main body 2 similarly to the intensity distribution spectrum generated by the first detector 77A.

The ultraviolet intensity distribution spectrum generated by the first detector 77A and the infrared intensity distribution spectrum generated by the second detector 77B are input to the controller 21. The controller 21 performs component analysis of the sample SP using a basic principle, which will be described later, based on the intensity distribution spectra. The controller 21 can perform the component analysis using a wider frequency range by using the ultraviolet intensity distribution spectrum and the infrared intensity distribution spectrum in combination.

The second beam splitter 78B reflects illumination light (visible light), which has been emitted from an LED light source 79a and passed through the optical element 79b, and irradiates the sample SP with the illumination light via the first beam splitter 78A, the dispersing element 75, the deflection element 73, and the reflective object lens 74. Reflection light (visible light) reflected by the sample SP returns to the analysis optical system 7 via the reflective object lens 74.

The coaxial illuminator 79 includes the LED light source 79a that emits the illumination light, and the optical element 79b through which the illumination light emitted from the LED light source 79a passes. The coaxial illuminator 79 functions as a so-called “coaxial epi-illuminator”. The illumination light emitted from the LED light source 79a propagates coaxially with the laser light (primary electromagnetic wave) output from the emitter 71 and emitted to the sample SP and the light (secondary electromagnetic wave) returning from the sample SP.

Specifically, the coaxial illuminator 79 emits the illumination light via an optical path coaxial with the primary electromagnetic wave emitted from the emitter 71. Specifically, a portion connecting the deflection element 73 and the reflective object lens 74 in the optical path of the illumination light is coaxial with the optical path of the primary electromagnetic wave. Further, a portion connecting the first beam splitter 78A and the reflective object lens 74 in the optical path of the illumination light is coaxial with the optical path of the secondary electromagnetic wave.

Among beams of the reflection light returned to the analysis optical system 7, the second beam splitter 78B further transmits reflection light transmitted through the first beam splitter 78A and plasma light transmitted through the first beam splitter 78A without reaching the first and second detectors 77A and 77B, and causes the reflection light and the plasma light to enter the first camera 81 via the imaging lens 80.

Although the coaxial illuminator 79 is incorporated in the analysis housing 70 in the example illustrated in FIG. 7, the present disclosure is not limited to such a configuration. For example, a light source may be laid out outside the analysis housing 70, and the light source and the analysis optical system 7 may be coupled to the optical system via an optical fiber cable.

The side illuminator 84 is arranged to surround the reflective object lens 74. The side illuminator 84 emits illumination light from the side of the sample SP (in other words, a direction tilted with respect to the analysis optical axis Aa) although not illustrated.

The first camera 81 collects reflection light reflected by the sample SP via the reflective object lens 74. The first camera 81 captures an image of the sample SP by detecting a light reception amount of the collected reflection light.

Specifically, the first camera 81 according to the present embodiment photoelectrically converts light incident through the imaging lens 80 by a plurality of pixels arranged on a light receiving surface thereof, and converts the light into an electrical signal corresponding to an optical image of a subject (the sample SP).

The first camera 81 may have a plurality of light receiving elements arranged along the light receiving surface. In this case, each of the light receiving elements corresponds to a pixel so that an electrical signal based on the light reception amount in each of the light receiving elements can be generated. Specifically, the first camera 81 according to the present embodiment is configured using an image sensor including a complementary metal oxide semiconductor (CMOS), but is not limited to this configuration. As the first camera 81, for example, an image sensor including a charged-coupled device (CCD) can also be used.

Then, the first camera 81 inputs an electrical signal generated by detecting the light reception amount by each light receiving element to the controller 21 of the controller main body 2. The controller 21 generates image data corresponding to the optical image of the subject based on the input electrical signal.

The optical components that have been described so far are accommodated in the analysis housing 70. A through-hole 70a is provided in a lower surface of the analysis housing 70. The reflective object lens 74 faces the placement surface 51a via the through-hole 70a.

A shielding member 83 illustrated in FIG. 7 may be arranged in the analysis housing 70. The shielding member 83 is arranged between the through-hole 70a and the reflective object lens 74, and can be inserted on an optical path of laser light based on an electrical signal input from the controller main body 2 (see the dotted line in FIG. 7). The shielding member 83 is configured not to transmit at least the laser light.

The emission of laser light from the analysis housing 70 can be restricted by inserting the shielding member 83 on the optical path. The shielding member 83 may be arranged between the emitter 71 and the output adjuster 72.

As illustrated in FIG. 8, the analysis housing 70 also defines an accommodation space of the slide mechanism 65 in addition to an accommodation space of the analysis optical system 7. In that sense, the analysis housing 70 can also be regarded as an element of the slide mechanism 65.

Specifically, the analysis housing 70 according to the present embodiment is formed in a box shape in which a dimension in the front-rear direction is shorter than a dimension in the left-right direction. Then, a left side portion of a front surface 70b of the analysis housing 70 protrudes forward so as to secure a movement margin of the guide rail 65a in the front-rear direction. Hereinafter, such a protruding portion is referred to as a “protrusion”, and is denoted by reference sign 70c. The protrusion 70c is arranged at a lower half of the front surface 70b in the vertical direction (in other words, only a lower half of the left side portion of the front surface 70b protrudes).

-Basic Principle of Analysis by Analysis Optical System 7-

The controller 21 executes component analysis of the sample SP based on the intensity distribution spectra input from the first detector 77A and the second detector 77B as detectors. As a specific analysis method, the LIBS method can be used as described above. The LIBS method is a method for analyzing a component contained in the sample SP at an element level (so-called elemental analysis method).

Generally, when high energy is applied to a substance, an electron is separated from an atomic nucleus, so that the substance is turned into a plasma state. The electron separated from the atomic nucleus temporarily becomes a high-energy and unstable state, but loses energy from such a state and is captured again by the atomic nucleus to transition to a low-energy and stable state (in other words, returns from the plasma state to a non-plasma state).

Here, the energy lost from the electron is emitted from the electron as the electromagnetic wave, but the magnitude of the energy of the electromagnetic wave is defined by an energy level based on a shell structure unique to each element. That is, the energy of the electromagnetic wave emitted when the electron returns from the plasma to the non-plasma state has a unique value for each element (more precisely, a trajectory of the electron bound to the atomic nucleus). The magnitude of energy of an electromagnetic wave is defined by a wavelength of the electromagnetic wave. Therefore, the components contained in the substance can be analyzed at the element level by analyzing a wavelength distribution of the electromagnetic wave emitted from the electron, that is, a wavelength distribution of the light emitted from the substance at the time of the plasma state. Such a technique is generally called an atomic emission spectroscopy (AES) method.

The LIBS method is an analysis method belonging to the AES method. Specifically, in the LIBS method, the substance (sample SP) is irradiated with laser (primary electromagnetic wave) to apply energy to the substance. Here, a site irradiated with the laser is locally turned into plasma, and thus, component analysis of the substance can be performed by analyzing the intensity distribution spectrum of the plasma light (secondary electromagnetic wave) emitted with the turning into plasma.

That is, as described above, the wavelength of each plasma light (secondary electromagnetic wave) has the unique value for each element, and thus, an element corresponding to a peak becomes a component of the sample SP when the intensity distribution spectrum forms the peak at a specific wavelength. Then, when the intensity distribution spectrum includes a plurality of peaks, a component ratio of each element can be calculated by comparing the intensity (light reception amount) of each of the peaks.

According to the LIBS method, vacuuming is unnecessary, and component analysis can be performed in the atmospheric open state. Further, although the sample SP is subjected to a destructive test, it is unnecessary to perform a treatment such as dissolving the entire sample SP so that position information of the sample SP remains (the test is only locally destructive).

-Observation Unit 63-

The observation unit 63 includes the observation optical system 9 and the observation housing 90 in which the observation optical system 9 is accommodated. The observation optical system 9 is a set of components configured to observe the sample SP as the observation target, and the respective components are accommodated in the observation housing 90. Further, elements configured to observe the sample SP also include the controller 21 of the controller main body 2.

The observation optical system 9 includes a lens unit 9a having the objective lens 92. As illustrated in FIG. 3 and the like, the lens unit 9a corresponds to a cylindrical lens barrel arranged on the lower end side of the observation housing 90. The lens unit 9a is held by the observation housing 90. The lens unit 9a can be detached alone from the observation housing 90.

A communication cable C2 configured to transmit and receive an electrical signal to and from the controller main body 2 and an optical fiber cable C3 configured to guide illumination light from the outside are connected to the observation housing 90. Note that the communication cable C2 is not essential, and the observation optical system 9 and the controller main body 2 may be connected by wireless communication.

Specifically, the observation optical system 9 includes a mirror group 91, the objective lens 92, the second camera 93 which is the second camera, a second coaxial illuminator 94, and a second side illuminator 95 as illustrated in FIG. 6.

The objective lens 92 has the observation optical axis Ao extending along the substantially vertical direction, collects illumination light to be emitted to the sample SP placed on the placement stage main body 51, and collects light (reflection light) from the sample SP. The observation optical axis Ao is provided to be parallel to the analysis optical axis Aa of the reflective object lens 74 of the analysis optical system 7. The reflection light collected by the objective lens 92 is received by the second camera 93.

The mirror group 91 transmits the reflection light collected by the objective lens 92 to be guided to the second camera 93. The mirror group 91 according to the present embodiment can be configured using a total reflection mirror, a beam splitter, and the like as illustrated in FIG. 6. The mirror group 91 also reflects the illumination light emitted from the second coaxial illuminator 94 to be guided to the objective lens 92.

The second camera 93 collects the reflection light collected by the objective lens 92 and detects a light reception amount of the reflection light to capture an image of the sample SP. Specifically, the second camera 93 according to the present embodiment photoelectrically converts light incident from the sample SP through the objective lens 92 by a plurality of pixels arranged on a light receiving surface thereof, and converts the light into an electrical signal corresponding to an optical image of the subject (sample SP).

The second camera 93 may have a plurality of light receiving elements arranged along the light receiving surface. In this case, each of the light receiving elements corresponds to a pixel so that an electrical signal based on the light reception amount in each of the light receiving elements can be generated. The second camera 93 according to the present embodiment includes an image sensor including a CMOS similarly to the first camera 81, but an image sensor including a CCD can also be used.

Then, the second camera 93 inputs an electrical signal generated by detecting the light reception amount by each light receiving element to the controller 21 of the controller main body 2. The controller 21 generates image data corresponding to the optical image of the subject based on the input electrical signal.

The second coaxial illuminator 94 emits the illumination light guided from the optical fiber cable C3. The second coaxial illuminator 94 emits the illumination light through an optical path common to the reflection light collected through the objective lens 92. That is, the second coaxial illuminator 94 functions as a “coaxial epi-illuminator” coaxial with the observation optical axis Ao of the objective lens 92. Note that a light source may be incorporated in the lens unit 9a, instead of guiding the illumination light from the outside through the optical fiber cable C3. In that case, the optical fiber cable C3 is unnecessary.

As schematically illustrated in FIG. 6, the second side illuminator 95 is configured by a ring illuminator arranged so as to surround the objective lens 92. The second side illuminator 95 emits illumination light from obliquely above the sample SP similarly to the side illuminator 84 in the analysis optical system 7.

-Housing Coupler 64-

The housing coupler 64 is a member configured to couple the observation housing 90 to the analysis housing 70. The housing coupler 64 couples both the housings 70 and 90, so that the analysis optical system 7 and the observation optical system 9 move integrally.

The housing coupler 64 can be attached to the inside or outside the analysis housing 70, or to the stand 42. In particular, the housing coupler 64 is attached to an outer surface of the analysis housing 70 in the present embodiment.

Specifically, the housing coupler 64 according to the present embodiment is configured to be attachable to the protrusion 70c of the analysis housing 70 and to hold the lens unit 9a on the right side of the protrusion 70c.

Further, a front surface of the protrusion 70c protrudes forward from a front portion of the housing coupler 64 and the observation housing 90 in a state where the observation housing 90 is coupled to the analysis housing 70 by the housing coupler 64 as illustrated in FIG. 3. In this manner, the observation housing 90 and at least a part of the analysis housing 70 (the protrusion 70c in the present embodiment) are laid out so as to overlap each other when viewed from the side (when viewed from a direction orthogonal to the moving direction of the observation optical system 9 and the analysis optical system 7 by the slide mechanism 65) in the state where the housing coupler 64 holds the observation housing 90 in the present embodiment.

The housing coupler 64 according to the present embodiment can fix the relative position of the analysis optical axis Aa with respect to the observation optical axis Ao by fixing the observation housing 90 to the analysis housing 70.

Specifically, as illustrated in FIG. 8, the housing coupler 64 holds the observation housing 90, so that the observation optical axis Ao and the analysis optical axis Aa are arranged side by side along the direction (front-rear direction in the present embodiment) in which the observation optical system 9 and the analysis optical system 7 relatively move with respect to the placement stage 5 by the slide mechanism 65. In particular, the observation optical axis Ao is arranged on the front side as compared with the analysis optical axis Aa in the present embodiment.

Further, as illustrated in FIG. 8, the observation optical axis Ao and the analysis optical axis Aa are arranged such that positions in a non-moving direction (the left-right direction in the present embodiment), which is a direction that extends along the horizontal direction and is orthogonal to the moving direction (the front-rear direction in the present embodiment), coincide with each other when the housing coupler 64 holds the observation housing 90.

-Slide Mechanism 65-

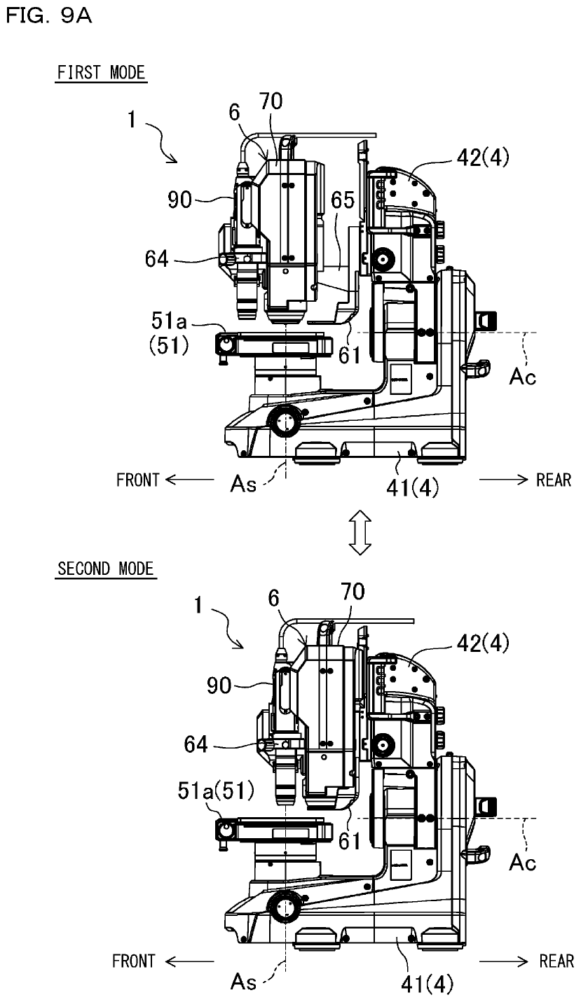

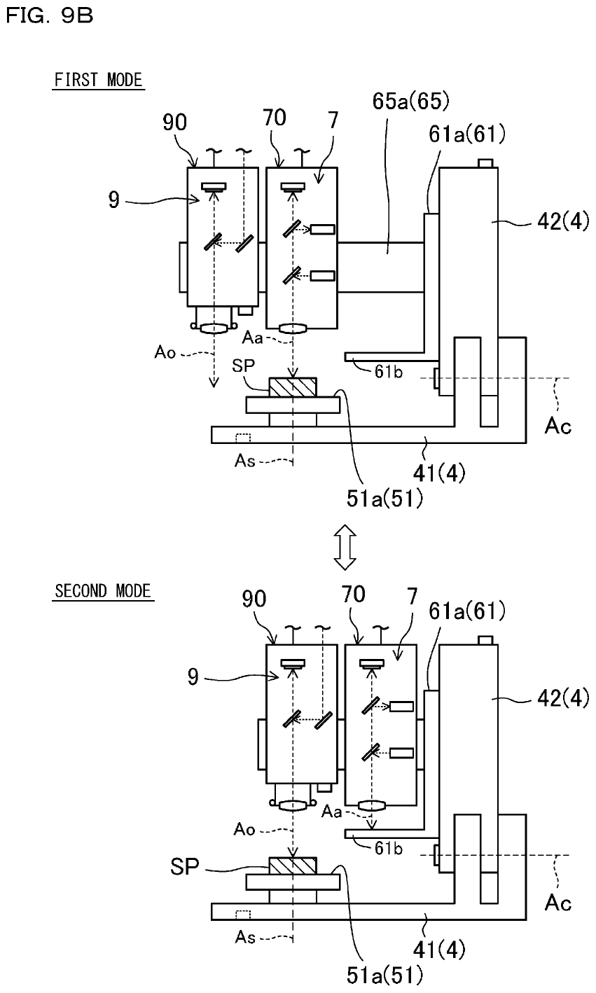

FIG. 8 is a schematic view for describing the configuration of the slide mechanism 65. Further, FIGS. 9A and 9B are views for describing horizontal movement of the head 6.

The slide mechanism 65 is configured to move the relative positions of the observation optical system 9 and the analysis optical system 7 with respect to the placement stage main body 51 along the horizontal direction such that the capturing of the sample SP by the observation optical system 9 and the irradiation of the electromagnetic wave (laser light) (in other words, the irradiation of the electromagnetic wave by the emitter 71 of the analysis optical system 7) in the case of generating the intensity distribution spectrum by the analysis optical system 7 can be performed on the identical point in the sample SP as the observation target.

The moving direction of the relative position by the slide mechanism 65 can be a direction in which the observation optical axis Ao and the analysis optical axis Aa are arranged. As illustrated in FIG. 8, the slide mechanism 65 according to the present embodiment moves the relative positions of the observation optical system 9 and the analysis optical system 7 with respect to the placement stage main body 51 along the front-rear direction.

The slide mechanism 65 according to the present embodiment relatively displaces the analysis housing 70 with respect to the stand 42 and the head attachment member 61. Since the analysis housing 70 and the lens unit 9a are coupled by the housing coupler 64, the lens unit 9a is also integrally displaced by displacing the analysis housing 70.

Specifically, the slide mechanism 65 according to the present embodiment includes the guide rail 65a and an actuator 65b, and the guide rail 65a is formed to protrude forward from a front surface of the head attachment member 61.

Specifically, a proximal end of the guide rail 65a is fixed to the head attachment member 61. On the other hand, a distal side portion of the guide rail 65a is inserted into an accommodation space defined in the analysis housing 70, and is attached to the analysis housing 70 in an insertable and removable state. An insertion and removal direction of the analysis housing 70 with respect to the guide rail 65a is equal to a direction (the front-rear direction in the present embodiment) in which the head attachment member 61 and the analysis housing 70 are separated or brought close to each other.

The actuator 65b can be configured using, for example, a linear motor or a stepping motor that operates based on an electrical signal from the controller 21. It is possible to relatively displace the analysis housing 70, and eventually, the observation optical system 9 and the analysis optical system 7 with respect to the stand 42 and the head attachment member 61 by driving the actuator 65b. When the stepping motor is used as the actuator 65b, a motion conversion mechanism that converts a rotational motion of an output shaft in the stepping motor into a linear motion in the front-rear direction is further provided.

The slide mechanism 65 further includes a movement amount sensor Sw2 configured to detect each movement amount of the observation optical system 9 and the analysis optical system 7. The movement amount sensor Sw2 can be configured using, for example, a linear scale (linear encoder), a photointerrupter, or the like.

The movement amount sensor Sw2 detects a relative distance between the analysis housing 70 and the head attachment member 61, and inputs an electrical signal corresponding to the relative distance to the controller main body 2. The controller main body 2 calculates the amount of change in the relative distance input from the movement amount sensor Sw2 to determine each displacement amount of the observation optical system 9 and the analysis optical system 7.

When the slide mechanism 65 is operated, the head 6 slides along the horizontal direction, and the relative positions of the observation optical system 9 and the analysis optical system 7 with respect to the placement stage 5 move (horizontally move) as illustrated in FIGS. 9A and 9B. This horizontal movement causes the head 6 to switch between a first mode in which the reflective object lens 74 faces the sample SP and a second mode in which the objective lens 92 faces the sample SP. The slide mechanism 65 can slide the analysis housing 70 and the observation housing 90 between the first mode and the second mode.

As illustrated in FIGS. 9A and 9B, the head 6 is in a relatively advanced state in the first mode, and the head 6 is in a relatively retracted state in the second mode. The first mode is an operation mode for performing component analysis of the sample SP by the analysis optical system 7, and the second mode is an operation mode for performing magnifying observation of the sample SP by the observation optical system 9.

In particular, the analysis and observation device A according to the present embodiment is configured such that a point to which the reflective object lens 74 is directed in the first mode and a point to which the objective lens 92 is directed in the second mode are the same point. Specifically, the analysis and observation device A is configured such that a point where the analysis optical axis Aa intersects with the sample SP in the first mode and a point where the observation optical axis Ao intersects with the sample SP in the second mode are the same (see FIG. 9B).

In order to implement such a configuration, a movement amount D2 of the head 6 when the slide mechanism 65 is operated is set to be the same as a distance D1 between the observation optical axis Ao and the analysis optical axis Aa (see FIG. 8). In addition, the arrangement direction of the observation optical axis Ao and the analysis optical axis Aa is set to be parallel to a moving direction of the head 6 as illustrated in FIG. 8.

Further, a distance between the sample SP and a center (more specifically, a site where the analysis optical axis Aa and the reflective object lens 74 intersect with each other) of the reflective object lens 74 in the first mode is set to coincide with a distance between the sample SP and a center (more specifically, a site where the observation optical axis Ao and the objective lens 92 intersect with each other) of the objective lens 92 in the second mode (second state) by adjusting the dimension of the housing coupler 64 in the substantially vertical direction in the present embodiment. This setting can also be performed by obtaining an in-focus position by autofocus.

Further, the reflective object lens 74 and the objective lens 92 may be designed such that working distances (WD) thereof coincide with each other. As a result, if a focused state is obtained before the mode switching, the focused state is maintained even after the mode switching, and the lens and the sample SP do not collide with each other at the time of the mode switching even in a state where the sample SP and the lens are extremely close to each other before the mode switching.

With the above configuration, the generation of the image of the sample SP by the observation optical system 9 and the generation of the intensity distribution spectrum by the analysis optical system 7 (specifically, the irradiation of the primary electromagnetic wave by the analysis optical system 7 when the intensity distribution spectrum is generated by the analysis optical system 7) can be executed on the same point in the sample SP from the same direction at timings before and after performing the switching between the first mode and the second mode.

Further, the cover member 61b in the head attachment member 61 is arranged so as to cover the reflective object lens 74 forming the analysis optical system 7 (shielding state) in the second mode in which the head 6 is in the relatively retracted state, and is arranged so as to be separated from the reflective object lens 74 (non-shieling state) in the first mode in which the head 6 is in the relatively advanced state as illustrated in FIG. 9B.

In the former shielding state, laser light can be shielded by the cover member 61b even if the laser light is unintentionally emitted. As a result, the safety of the device can be improved. Furthermore, it is possible to suppress entry of foreign matter into the analysis housing 70 when the laser light is not emitted.

(Details of Tilting Mechanism 45)

FIGS. 10A and 10B are views for describing an operation of the tilting mechanism 45. Hereinafter, the tilting mechanism 45, such as a relation with the housing coupler 64, will be described in detail with reference to FIGS. 10A and 10B.

The tilting mechanism 45 is a mechanism including the above-described shaft member 44 and the like, and can tilt at least the observation optical system 9 of the analysis optical system 7 and the observation optical system 9 with respect to the reference axis As perpendicular to the placement surface 51a.

As described above, the housing coupler 64 integrally couples the analysis housing 70 and the observation housing 90 such that the relative position of the observation optical axis Ao with respect to the analysis optical axis Aa is maintained in the present embodiment. Therefore, when the observation optical system 9 having the observation optical axis Ao is tilted, the analysis optical system 7 having the analysis optical axis Aa is tilted integrally with the observation optical system 9 as illustrated in FIGS. 10A and 10B.

In this manner, the tilting mechanism 45 according to the present embodiment integrally tilts the analysis optical system 7 and the observation optical system 9 while maintaining the relative position of the observation optical axis Ao with respect to the analysis optical axis Aa.

Further, an operation of the slide mechanism 65 and the operation of the tilting mechanism 45 are independent from each other, and a combination of both the operations is allowed. Therefore, the slide mechanism 65 can move the relative positions of the observation optical system 9 and the analysis optical system 7 in a state where at least the observation optical system 9 is held in a tilted posture by the tilting mechanism 45. That is, the analysis and observation device A according to the present embodiment can slide the head 6 back and forth in a state where the observation optical system 9 is tilted as indicated by the double-headed arrow A1 in FIG. 10B.

In particular, since the analysis optical system 7 and the observation optical system 9 are configured to be tilted integrally in the present embodiment, the slide mechanism 65 moves the relative positions of the observation optical system 9 and the analysis optical system 7 while maintaining the state where both the observation optical system 9 and the analysis optical system 7 are tilted by the tilting mechanism 45.

Further, the analysis and observation device A is configured to perform eucentric observation. That is, a three-dimensional coordinate system, which is unique to the device and is formed by three axes parallel to the X direction, the Y direction, and the Z direction, is defined in the analysis and observation device A. A secondary storage device 21c of the controller 21 further stores a coordinate of an intersection position, which will be described later, in the three-dimensional coordinate system of the analysis and observation device A. The coordinate information of the intersection position may be stored in the secondary storage device 21c in advance at the time of shipment of the analysis and observation device A from the factory. Further, the coordinate information of the intersection position stored in the secondary storage device 21c may be updatable by a user of the analysis and observation device A.

As illustrated in FIGS. 10A and 10B, assuming that an angle of the analysis optical axis Aa with respect to the reference axis As is referred to as a “tilt θ”, the analysis and observation device A is configured to allow the emission of laser light in a case where the tilt θ is less than a predetermined first threshold θmax, for example. A hard constraint can be imposed on the tilting mechanism 45 in order to keep the tilt θ less the first threshold θmax. For example, the tilting mechanism 45 may be provided with a brake mechanism (not illustrated) to physically restrict an operation range of the tilting mechanism 45.

The observation optical axis Ao, which is the optical axis of the objective lens 92, intersects with the central axis Ac. When the objective lens 92 swings about the central axis Ac, an angle (tilt θ) of the observation optical axis Ao with respect to the reference axis As changes while an intersection position between the observation optical axis Ao and the central axis Ac is maintained constant. In this manner, when the user swings the objective lens 92 about the central axis Ac by the tilting mechanism 45, a eucentric relation in which a visual field center of the second camera 93 does not move from the same observation target portion is maintained even if the objective lens 92 is in a tilted state, for example, in a case where an observation target portion of the sample SP is at the above-described intersection position. Therefore, it is possible to prevent the observation target portion of the sample SP from deviating from the visual field of the second camera 93 (visual field of the objective lens 92).

In particular, the analysis optical system 7 and the observation optical system 9 are configured to be tilted integrally in the present embodiment, and thus, the analysis optical axis Aa, which is the optical axis of the reflective object lens 74, intersects with the central axis Ac similarly to the observation optical axis Ao. When the reflective object lens 74 swings about the central axis Ac, an angle (tilt θ) of the analysis optical axis Aa with respect to the reference axis As changes while an intersection position between the analysis optical axis Aa and the central axis Ac is maintained constant.

Further, the tilting mechanism 45 can tilt the stand 42 rightward by about 90° or leftward by about 60° with respect to the reference axis As as described above. However, in the case where the analysis optical system 7 and the observation optical system 9 are configured to be integrally tilted, there is a possibility that laser light emitted from the analysis optical system 7 is emitted toward the user if the stand 42 is excessively tilted.

Therefore, assuming that the tilt of each of the observation optical axis Ao and the analysis optical axis Aa with respect to the reference axis As is 0, it is desirable that the tilt θ falls within a range satisfying a predetermined safety standard at least under a situation where laser light can be emitted. Specifically, the tilt θ according to the present embodiment can be adjusted within a range below the predetermined first threshold θmax as described above.

<Details of Controller Main Body 2>

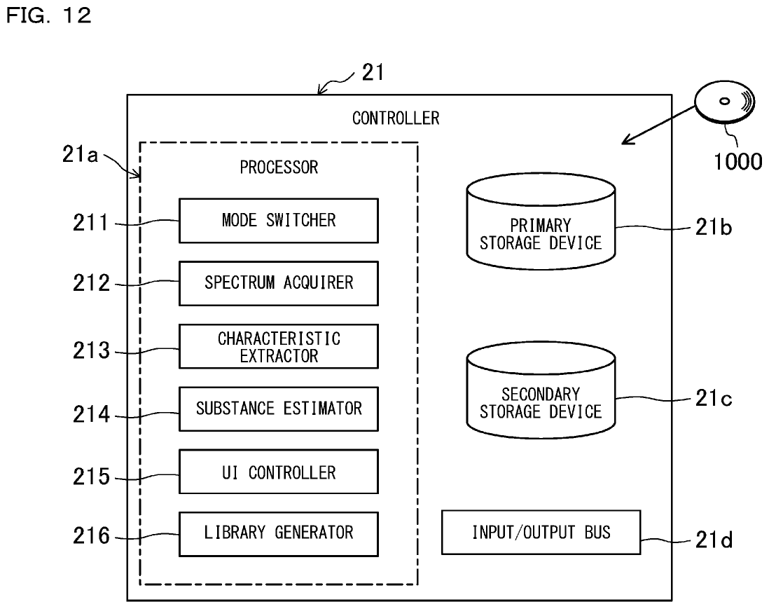

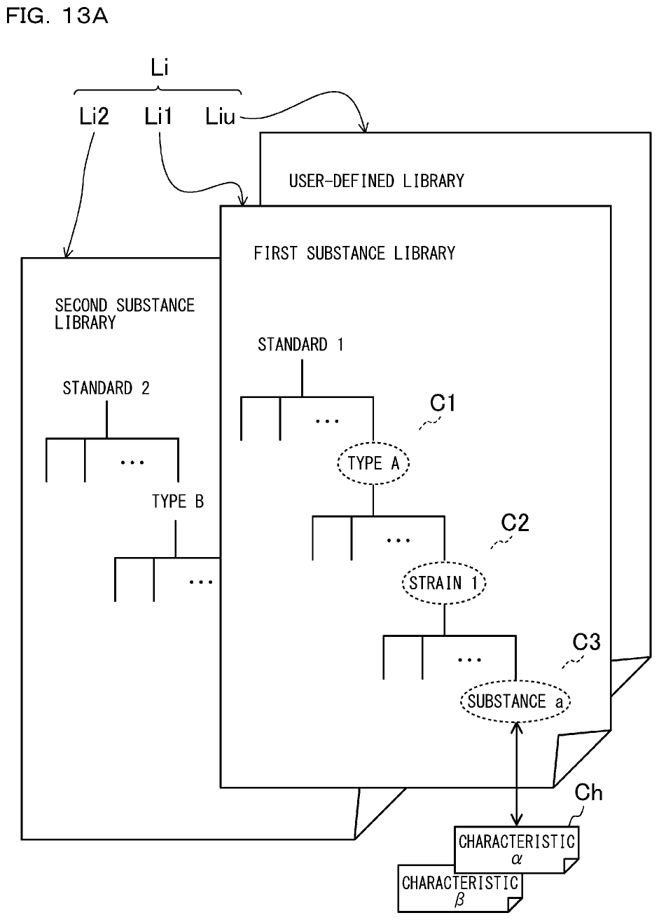

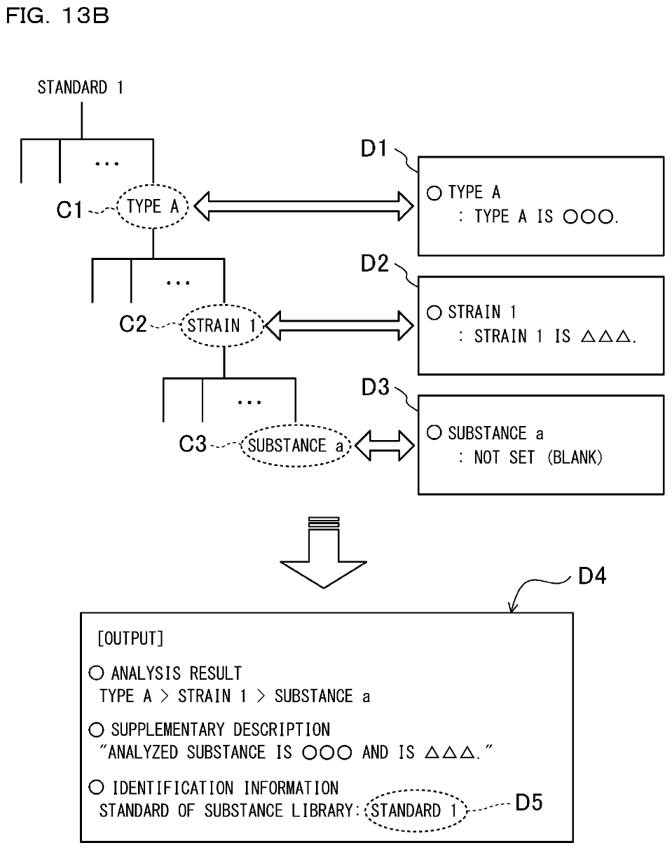

FIG. 11 is a block diagram illustrating the configuration of the controller main body 2. Further, FIG. 12 is a block diagram illustrating the configuration of the controller 21. Further, FIGS. 13A and 13B are views for describing a basic concept of the analysis method according to the present disclosure. The controller main body 2 and the optical system assembly 1 are configured separately in the present embodiment, but the present disclosure is not limited to such a configuration. At least a part of the controller main body 2 may be provided in the optical system assembly 1. For example, at least a part of the processor 21a constituting the controller 21 can be incorporated in the optical system assembly 1.

As described above, the controller main body 2 according to the present embodiment includes the controller 21 that performs various processes and the display 22 that displays information related to the processes performed by the controller 21. The controller 21 is electrically connected with at least the mouse 31, the console 32, the keyboard 33, the head drive 47, the placement stage drive 53, the actuator 65b, the emitter 71, the output adjuster 72, the LED light source 79a, the first camera 81, the shielding member 83, the side illuminator 84, the second camera 93, the second coaxial illuminator (second coaxial illumination) 94, the second side illuminator (second side illuminator) 95, a lens sensor Sw1, the movement amount sensor Sw2, the first tilt sensor Sw3, and the second tilt sensor Sw4.

The controller 21 electrically controls the head drive 47, the placement stage drive 53, the actuator 65b, the emitter 71, the output adjuster 72, the LED light source 79a, the first camera 81, the shielding member 83, the side illuminator 84, the second camera 93, the second coaxial illuminator 94, and the second side illuminator 95.

Further, output signals of the first camera 81, the second camera 93, the lens sensor Sw1, the movement amount sensor Sw2, the first tilt sensor Sw3, and the second tilt sensor Sw4 are input to the controller 21. The controller 21 executes calculation or the like based on the input output signal, and executes processing based on a result of the calculation. As hardware for performing such processing, the controller 21 according to the present embodiment includes the processor 21a that executes various types of processing, a primary storage device 21b and the secondary storage device 21c that store data related to the processing performed by the processor 21a, and an input/output bus 21d.

The processor 21a includes a CPU, a system LSI, a DSP, and the like. The processor 21a executes various programs to analyze the sample SP and control the respective sections of the analysis and observation device A such as the display 22. In particular, the processor 21a according to the present embodiment can execute processing based on a substance library Li. This substance library Li refers to a set of data in which a type of a substance constituting the sample SP and a characteristic constituting the substance are stored in association with each other as will be described later.

Further, the processor 21a according to the present embodiment includes, as functional elements, a mode switcher 211, a spectrum acquirer 212, a characteristic extractor 213, a substance estimator 214, a user interface controller (hereinafter, simply referred to as “UI controller”) 215, and a library generator 216. These elements may be implemented by a logic circuit or may be implemented by executing software. Further, at least some of these elements, such as the head 6, can also be provided in the optical system assembly 1.

The primary storage device 21b is configured using a volatile memory. The primary storage device 21b according to the present embodiment can read out the substance library Li from the secondary storage device 21c and the like and temporarily store the substance library Li. The primary storage device 21b is an example of a “storage section (storage)” in the present embodiment.

Here, as illustrated in FIG. 13A, the substance library Li includes pieces of hierarchical information of a superclass C1 representing a general term of substances considered to be contained in the sample SP and a subclass C3 representing a type of the substance belonging to the superclass C1. The superclass C1 may include at least one or more of the subclasses C3 belonging thereto.

For example, when the sample SP is a steel material, the superclass C1 may be a class such as alloy steel, carbon steel, and cast iron or may be a class, such as stainless steel, cemented carbide, and high-tensile steel, obtained by subdividing these classes. Further, an aluminum alloy may be added as a class other than a steel product, in addition to the alloy steel and the like.

Further, when the sample SP is the steel material, the subclass C3 may be a class such as austenitic stainless steel, precipitation hardening stainless steel, and ferritic stainless steel, or may be a class, such as SUS301 and SUS302, obtained by subdividing these classes based on, for example, Japanese Industrial Standards (JIS). The subclass C3 may be at least a class obtained by subdividing the superclass C1. Further, for example, duralumin can be used as the subclass C3 when the superclass C1 is set to an aluminum alloy. In other words, the superclass C1 may be a class to which at least some of the subclasses C3 belong.

On the other hand, when the sample SP is an organic compound, the superclass C1 may be a class based on the presence or absence of aromaticity, such as an aromatic compound and an aliphatic compound, may be a class based on a skeleton structure such as a chain compound and a cyclic compound or may be a class for each functional group, or these classes may be combined. Further, a class unique to a specific research field, such as a fat compound and a nucleic acid compound, may be used.

In this case, the subclass C3 may be a class obtained by subdividing a classification related to aromaticity, such as a benzenoid aromatic compound, a heteroaromatic compound, and a non-benzenoid aromatic compound, may be a class obtained by further subdividing the skeleton structure such as presence or absence of a C—H bond and a C═C bond, or may be a class obtained by combining these classes.

Further, one or more intermediate classes C2 may be provided between the superclass C1 and the subclass C3. In this case, the substance library Li is configured by storing the hierarchical information of the intermediate class C2 together with pieces of the hierarchical information of the superclass C1 and the subclass C3. This intermediate classes C2 represent a plurality of strains belonging to the superclass C1.

For example, in a case where the sample SP is a steel material, classes such as stainless steel, cemented carbide, and high-tensile steel are used as the superclasses C1, and classes such as SUS301, SUS302, and A2017 are used as the subclasses C3, the intermediate class C2 may be a class such as austenitic and precipitation hardening, or may be a class collectively referring to some of the subclasses C3 such as “SUS300 series”.

The substance library Li illustrated in FIG. 13A includes, for example, a first substance library and Li1 generated according to a first standard (Standard 1), and a second substance library Li generated according to a second standard (Standard 2) Li2. As the first or second standard, for example, it is possible to use a standard based on the International Organization for Standardization (ISO) (hereinafter, simply referred to as “ISO”), the EN standard (hereinafter simply referred to as “EN”) defined by the European Committee for Standardization, a standard defined by the American National Standards Institute (ANSI) (hereinafter simply referred to as “ANSI”), and the like in addition to the above-described JIS. In addition, a commercial standard or a similar database can be used. Furthermore, a user-defined substance library Liu generated according to a user's operation input can also be used as the substance library Li. Note that the library according to the standard such as JIS has been described herein, and thus, the present embodiment is not limited thereto. For example, unique libraries commonly used in a particular industry or field may be used. Furthermore, a library in which a plurality of substances are grouped from a user's own viewpoint may be used.

The primary storage device 21b according to the present embodiment can read out one or more of the first substance library Li1, the second substance library Li2, and the user-defined substance library as the substance library Li, and temporarily store this.

Further, the subclass C3 constituting the substance library Li is configured to be associated with the characteristic Ch of the substance considered to be contained in the sample SP. For example, in the case of using the LIBS method or the SEM or EDX method as the analysis method, the characteristic Ch of the substance contains information that summarizes a constituent element of the sample SP and a content (or content rate) of the constituent element in one set.

In this case, for each of substances constituting the subclass C3, a combination of constituent elements and an upper limit value and a lower limit value of a content (or a content rate) of each of the constituent elements are incorporated into the substance library Li, so that the subclass C3 can be estimated from the characteristic Ch of the substance as will be described later.

Note that the characteristic Ch of the substance also includes internal data of the analysis and observation device A in addition to the information that can be intuitively grasped by the user. For example, when an intensity distribution spectrum is analyzed through fitting of a model formula or the like, a parameter used for fitting the intensity distribution spectrum can be used as the characteristic Ch of the substance.

Further, in the case of using the method suitable for analysis of the organic compound, such as the IR method, information regarding details of a covalent bond, information indicating the presence or absence of a specific functional group in a constituent substance thereof, and the like can be used as the characteristic Ch of the substance.

Further, the substance library Li according to the present embodiment is configured by storing the superclass C1 and a supplementary description D1 regarding the general term of the substance represented by this superclass C1 in association with each other. This supplementary description D1 is configured using text data describing a property of each of the superclasses C1. Further, as illustrated in FIG. 13B, in addition to the superclass C1, the substance library Li is configured to further store an intermediate class C2 and a supplementary description D2 regarding a strain of the substance represented by the intermediate class C2 in association with each other. This supplementary description D2 is configured using text data describing a property of each of the intermediate classes C2. Regarding the subclass C3, a supplementary description D3 may be left blank (absence of the supplementary description) as illustrated in FIG. 13B, or text data describing a certain property may be stored (presence of the supplementary description) as in the superclass C1 and the intermediate class C2. It is also possible to individually set the presence or absence of the supplementary description D3 for each of the subclasses C3.

The secondary storage device 21c is configured using a non-volatile memory such as a hard disk drive and a solid state drive. The secondary storage device 21c can continuously store the substance libraries Li. Note that the substance library Li may be read out from the outside, such as a storage medium 1000, instead of storing the substance library Li in the secondary storage device 21c.

Further, the controller main body 2 can read out the storage medium 1000 storing a program (see FIG. 13B). In particular, the storage medium 1000 according to the present embodiment stores an analysis program obtained by programming the analysis method according to the present embodiment. This analysis program is read and executed by the controller main body 2. As the controller main body 2 executes the analysis program, the analysis and observation device A functions as the analysis device that executes the analysis method according to the present embodiment.

-Mode Switcher 211-

The mode switcher 211 switches from the first mode to the second mode or switches from the second mode to the first mode by advancing and retracting the analysis optical system 7 and the observation optical system 9 along the horizontal direction (the front-rear direction in the present embodiment).

Specifically, the mode switcher 211 according to the present embodiment reads, in advance, the distance between the observation optical axis Ao and the analysis optical axis Aa stored in advance in the secondary storage device 21c. Next, the mode switcher 211 operates the actuator 65b of the slide mechanism 65 to advance and retract the analysis optical system 7 and the observation optical system 9.

Here, the mode switcher 211 compares each displacement amount of the observation optical system 9 and the analysis optical system 7 detected by the movement amount sensor Sw2 with the distance read in advance, and determines whether or not the former displacement amount reaches the latter distance. Then, the advancement and retraction of the analysis optical system 7 and the observation optical system 9 are stopped at a timing when the displacement amount reaches a predetermined distance. Note that the predetermined distance may be determined in advance, or the predetermined distance and the maximum movable range of the actuator 65b may be configured to coincide with each other.

Note that the head 6 can be also tilted after switching to the first mode is performed by the mode switcher 211.

-Spectrum Acquirer 212-

The spectrum acquirer 212 acquires the intensity distribution spectrum via the first and second detectors 77A and 77B by emitting the primary electromagnetic wave or the primary ray from the analysis optical system 7 in the first mode.

Specifically, the spectrum acquirer 212 according to the present embodiment emits the primary electromagnetic wave or the primary ray (for example, laser light or electron beam) from the emitter 71. A secondary electromagnetic wave (for example, plasma light) generated by emitting the primary electromagnetic wave or the primary ray reaches the first detector 77A and the second detector 77B.

The first and second detectors 77A and 77B as the detectors generate the intensity distribution spectra based on the secondary electromagnetic waves arriving at each of them. The intensity distribution spectra thus generated are acquired by the spectrum acquirer 212.

-Characteristic Extractor 213-

The characteristic extractor 213 extracts the characteristic Ch of the substance contained in the sample SP as a constituent component based on the intensity distribution spectrum acquired by the spectrum acquirer 212. For example, in the case of using the LIBS method or the SEM or EDX method as the analysis method, the characteristic extractor 213 calculates a peak position in the acquired intensity distribution spectrum and a height of the peak. The characteristic extractor 213 extracts a constituent element of the sample SP and a content of the constituent element as the characteristic Ch of the substance based on the peak position and the peak height thus calculated.

Here, the characteristic extractor 213 can extract the characteristic Ch of the substance by fitting the intensity distribution spectrum using a predetermined model formula. In that case, the characteristic Ch of the substance can include various parameters in the model formula in addition to or instead of information that can be intuitively grasped by the user. Furthermore, in a case of using machine learning, such as a neural network, is used, the intensity distribution spectrum itself may be used as the characteristic Ch.

Further, in a case of using a method suitable for analysis of an organic substance such as an NMR method and an IR method, the characteristic extractor 213 extracts one or more peak positions from the intensity distribution spectrum and acquires a coupling structure corresponding to the peak positions as the characteristic Ch of the substance. In this case, the characteristic extractor 213 can acquire details of a covalent bond among the constituent substances of the sample SP, and can acquire the presence or absence of a specific functional group in the constituent substances.

-Substance Estimator 214-

The substance estimator 214 estimates a type of substance from the subclasses C3 based on the characteristic Ch of the substance extracted by the characteristic extractor 213 and the substance library Li read by the secondary storage device 21b.

As described above, the subclass C3 constituting the substance library Li is configured to be associated with the characteristic Ch of the substance considered to be contained in the sample SP. Therefore, the substance estimator 214 collates the characteristic Ch of the substance extracted by the characteristic extractor 213 with the substance library Li read by the secondary storage device 21b, thereby estimating, from subclass C3, the substance from which the characteristic Ch has been extracted. The collation here refers to not only calculating the similarity degree with representative data registered in the substance library Li but also the general act of acquiring an index indicating the accuracy of a substance using the parameter group registered in the substance library Li.

Here, not only a case where the subclass C3 and the characteristic Ch are uniquely linked like a “substance a” and a “characteristic a” illustrated in FIG. 13A, but also a case where there are a plurality of candidates of the subclasses C3 corresponding to the “characteristic a” is conceivable. In that case, the characteristic extractor 213 estimates a plurality of substances each having a relatively high accuracy among substances that are likely to be contained in the sample SP from among the subclasses C3, and outputs the estimated subclasses C3 in descending order of the accuracy. Here, as the accuracy, an index based on a parameter obtained at the time of analyzing the intensity distribution spectrum can be used. For example, when the intensity distribution spectrum is analyzed by fitting the model formula, it is possible to use an index indicating a probability of the fitting, such as a residual sum of squares between the model formula obtained by the fitting and the intensity distribution spectrum acquired by the spectrum acquirer 212. Alternatively, when various parameter groups or identification spaces trained by machine learning are registered in the substance library Li, the accuracy for each of the subclasses C3 can be obtained from the parameter groups or the identification spaces.

Further, when the first substance library Li1 and the second substance library Li2 are read by the secondary storage device 21b as described with reference to FIG. 13A, the substance estimator 214 may collate one of the first substance library Li1 and the second substance library Li2 with the characteristic Ch of the substance, or collate both the first substance library Li1 and the second substance library Li2 with the characteristic Ch of the substance. In particular, the substance estimator 214 according to the present embodiment can switch between a control mode in which one of the first and second substance libraries Li1 and Li2 is collated with the characteristic Ch of the substance and a control mode in which both the first and second substance libraries Li1 and Li2 are collated with the characteristic Ch of the substance, based on the user's operation input.

In the latter control mode, the substance estimator 214 can estimate a plurality of substances each having a relatively high accuracy among the substances that are likely to be contained in the sample SP from the subclasses C3 belonging to the first substance library Li1 and the subclasses C3 belonging to the second substance library Li2. For example, when the subclasses C3 belonging to the first substance library Li1 include N1 substances in total and the subclasses C3 belonging to the second substance library Li2 include N2 substances in total, the substance estimator 214 estimates the subclasses C3 corresponding to the characteristic Ch of the substance from among the N1+N2 subclasses C3.

Further, the same also applies in a case where the user-defined substance library Liu is included in the substance library Li. In this case, the substance estimator 214 can estimate a plurality of substances each having a relatively high accuracy among the substances that are likely to be contained in the sample SP from the subclasses C3 belonging to the first substance library Li1 and the subclasses C3 belonging to the user-defined substance library. Note that, in a case where there are a plurality of the subclasses C3 whose accuracies are relatively equal as a substance that is likely to be contained in the sample SP and it is difficult to determine superiority or inferiority using the subclass C3, the substance that is likely to be contained in the sample SP may be estimated from the superclass C1 or the intermediate class C2 to which the subclasses C3 belongs, instead of the subclass C3.

Further, the substance estimator 214 collates the estimated subclass C3 with the substance library Li to estimate the intermediate class C2 and the superclass C1 to which the subclass C3 belongs. An electrical signal indicating a result of the estimation result is input to the UI controller 215.

-UI Controller 215-

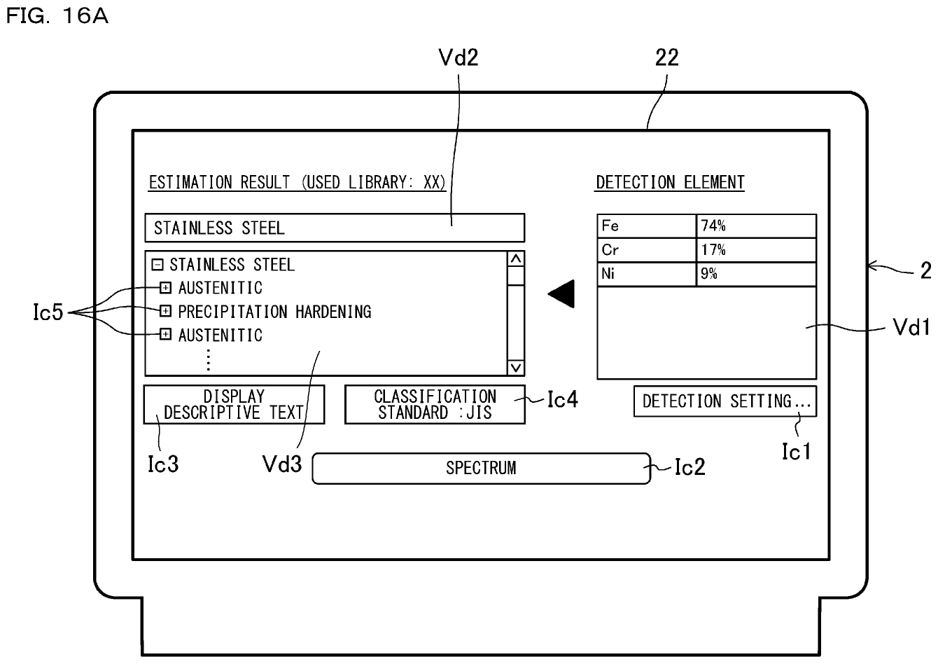

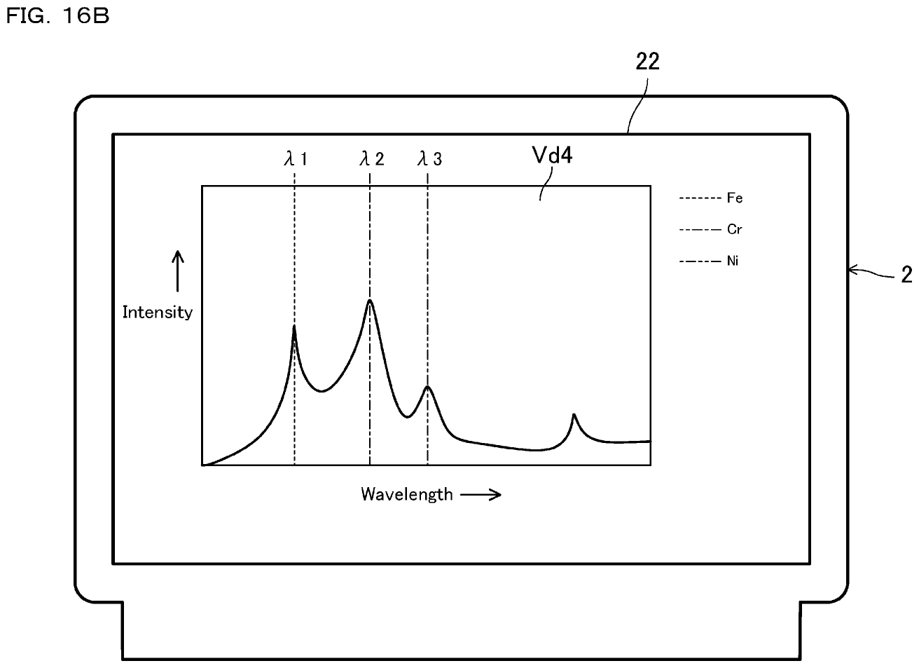

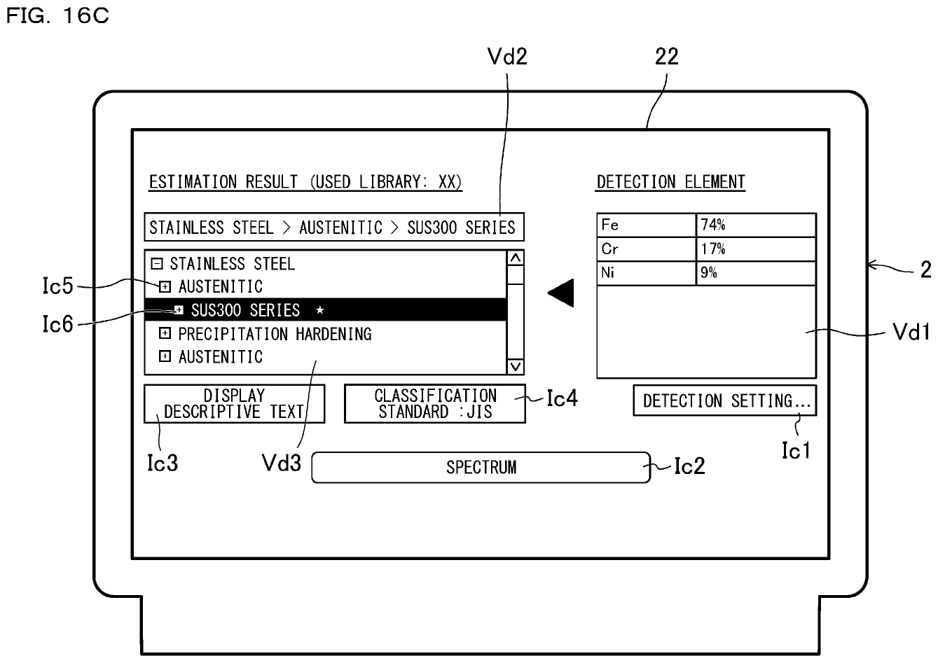

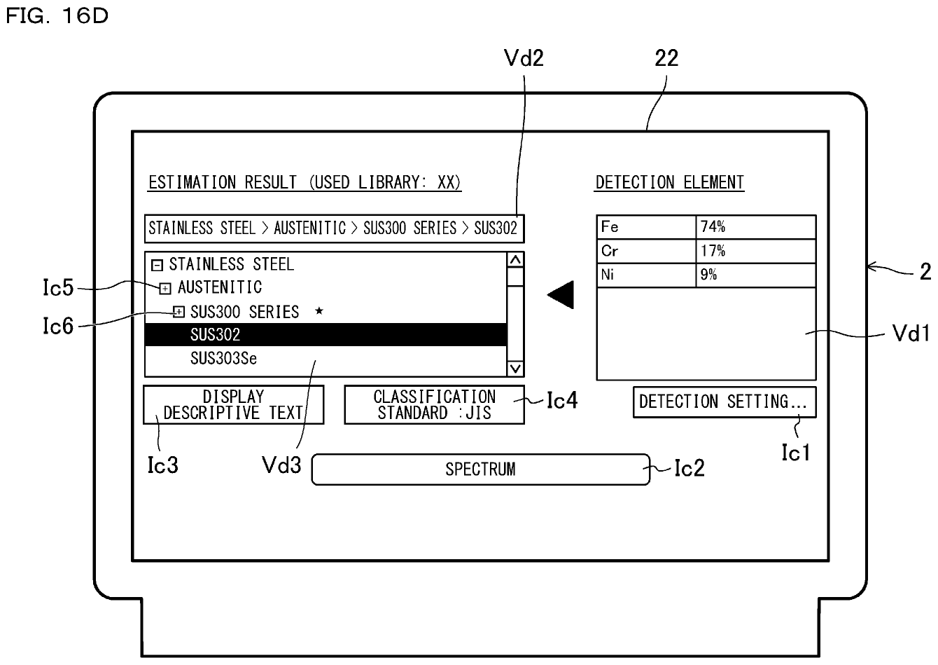

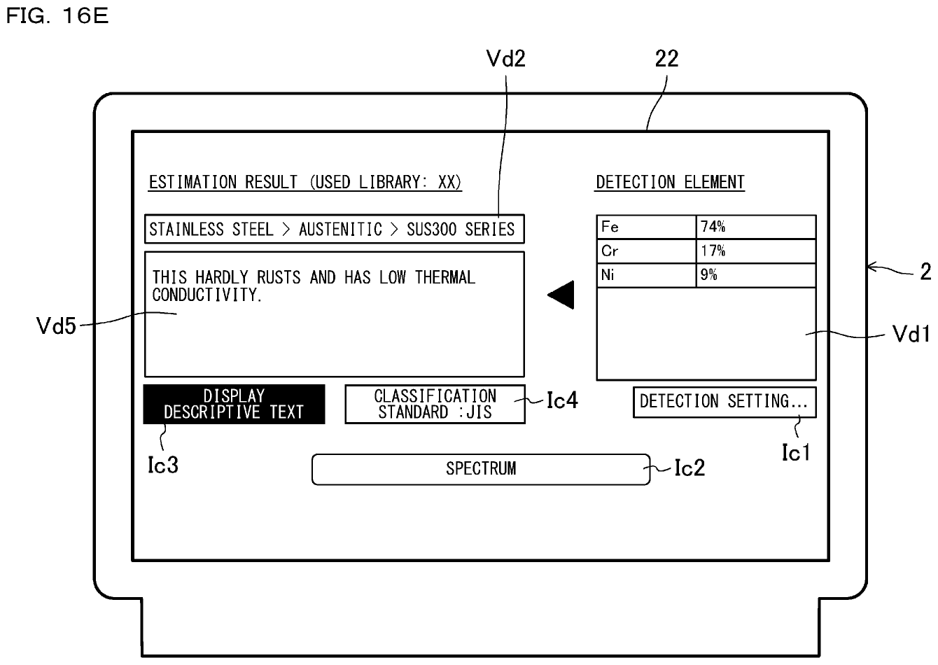

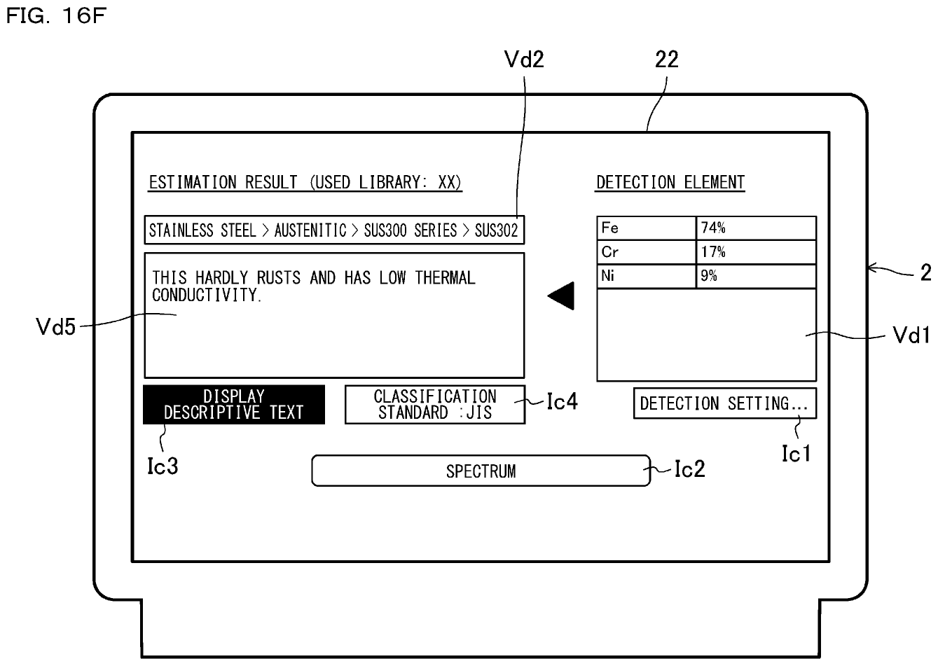

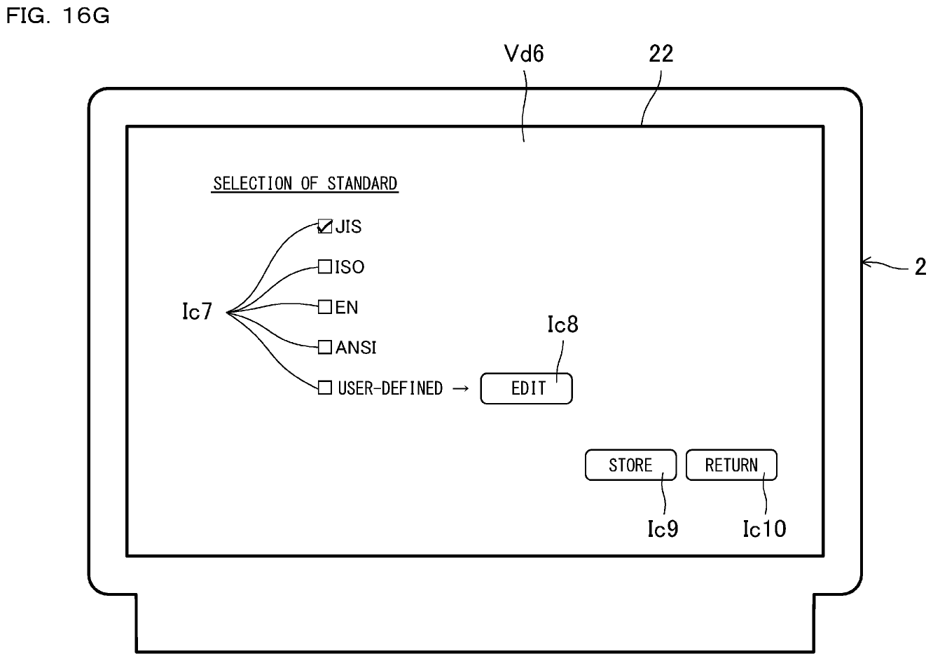

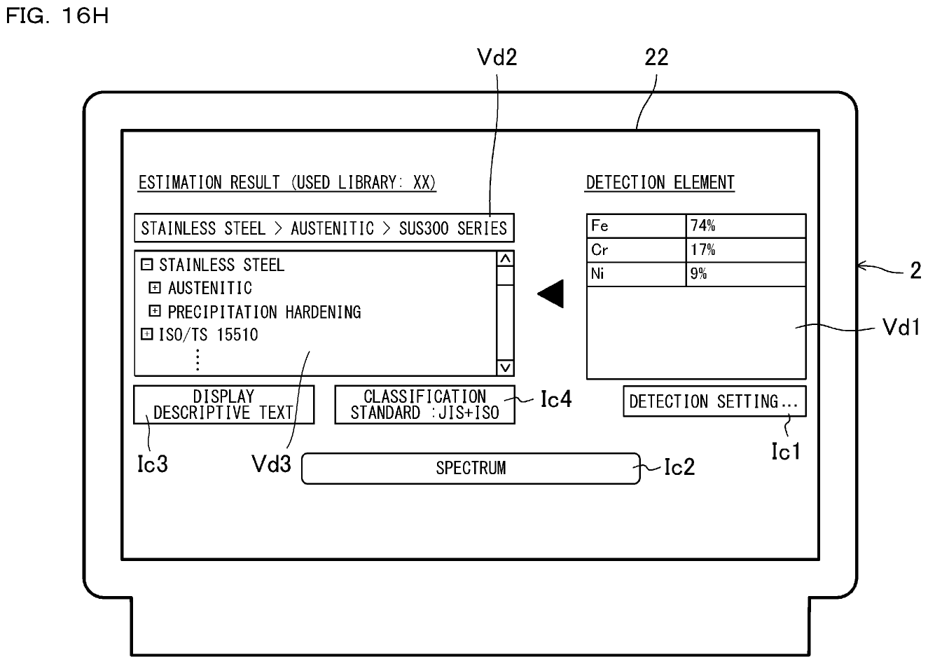

The UI controller 215 causes the display 22 to hierarchically displays the subclass C3 estimated by the substance estimator 214 and the superclass C1 to which the subclass C3 belongs. As a content to be displayed on the display 22, a tree structure illustrating a hierarchical relationship between the subclass C3 and the superclass C1 may be displayed as illustrated in FIGS. 13A and 13B, or only a structure related to a specific subclass C3 may be displayed out of a hierarchical structure as exemplified with FIGS. 16A to 1611 to be described later.

Further, when the intermediate class C2 is set between the superclass C1 and the subclass C3, the UI controller 215 can also display the intermediate class C2 to which the subclass C3 belongs based on the electrical signal input from the substance estimator 214. As in an output D4 illustrated in the lower part of FIG. 13B, the UI controller 215 can cause the display 22 to display the subclass C3 estimated by the substance estimator 214, the intermediate class C2 to which the subclass C3 belongs, and the superclass C1 to which the intermediate class C2 belongs, as the analysis result, in a state of indicating an inclusion relationship among the respective classes.

As mentioned in the description of the substance library Li, the superclass C1 is stored in association with the supplementary description D1. Therefore, the UI controller 215 according to the present embodiment can receive one selection from among the superclass C1 displayed on the display 22, and cause the display 22 to display the supplementary description D1 associated with the selected superclass C1. Further, the UI controller 215 can receive one selection from among the subclasses C3 displayed on the display 22, and cause the display 22 to display the supplementary description D1 associated with the superclass C1 to which the selected subclass C3 belongs.

That is, the UI controller 215 according to the present embodiment can cause the display 22 to display the supplementary description D1 associated with a predetermined superclass C1 when the superclass C1 has been selected, and cause the display 22 to display the same supplementary description D1 even when the subclass C3 belonging to this superclass C1 has been selected. Here, in a case where the supplementary description D3 is also stored in the subclass C3, the UI controller 215 can display both the supplementary description D1 related to the superclass C1 and the supplementary description D3 related to the subclass C3 as illustrated in FIG. 13B.

The same applies in a case where the intermediate class C2 is set. As in the output D4 illustrated in the lower part of FIG. 13B, the UI controller 215 can cause the display 22 to display text data obtained by combining the supplementary description D1 related to the superclass C1 and the supplementary description D2 related to the intermediate class C2 as a supplementary description.

Further, the UI controller 215 can cause the display 22 to display the subclass C3 estimated by the substance estimator 214 with identification information D5 indicating any of the first substance library Li1, the second substance library Li2, and the user defined substance library Liu to which this subclass C3 belongs. As illustrated in FIG. 13B, the display 22 may display the identification information D5 as one set with the information such as the analysis result and the supplementary description.

-Library Generator 216-

The library generator 216 generates the user-defined substance library based on the user's operation input. The library generator 216 can set the respective names and the hierarchical information of the superclass C1, the intermediate class C2, and the subclass C3, and set the supplementary description D1 related to the superclass C1, the supplementary description D2 related to the intermediate class C2, and the supplementary description D3 related to the subclass C3. The user-defined substance library Liu generated by the library generator 216 is stored in the secondary storage device 21c, and is read and used by the substance estimator 214 or the like as necessary. Here, for the superclass C1, the intermediate class C2, and the subclass C3, definitions uniquely defined by the user can be registered or a part thereof can be quoted from existing standards. The user can arbitrarily add and edit the hierarchical structure among the classes and the supplementary descriptions associated with the respective classes. Further, information indicating the characteristic Ch extracted by the characteristic extractor 213, for example, a composition of a substance, can be directly registered in any of the superclass C1, the intermediate class C2, and the subclass C3 or be automatically set as an initial value. Further, when a substance is estimated by machine learning, training can be performed using the characteristic Ch registered by the user. As a result, it is possible to perform appropriate estimation even for a user-specific substance that does not exist in the existing standards.

<Specific Example of Control Flow>

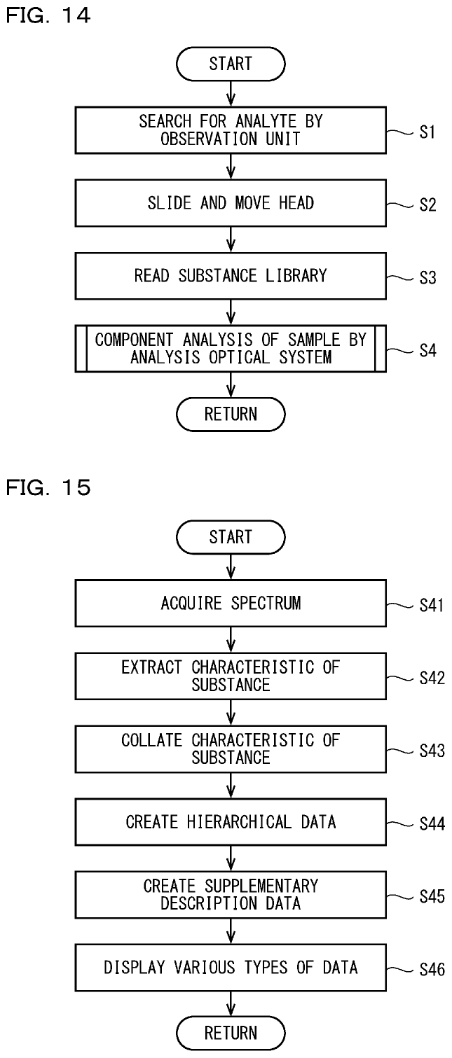

FIG. 14 is a flowchart illustrating a basic operation of the analysis and observation device A. Further, FIG. 15 is a flowchart illustrating an analysis procedure of the sample SP performed by the controller 21.

First, the observation optical system 9 searches for an analyte in the second mode in step S1 of FIG. 14. In this step S1, the controller 21 searches for a portion (analyte) to be analyzed by the analysis optical system 7 among portions of the sample SP while adjusting conditions, such as the exposure time of the second camera 93 and the brightness of image data generated by the second camera 93, such as illumination light guided by the optical fiber cable C3, based on an operation input by the user. At this time, the controller 21 stores the image data generated by the second camera 93 as necessary.

In the subsequent step S2, the controller 21 receives an instruction for switching from the second mode to the first mode based on an operation input by the user. Then, the mode switcher 211 operates the slide mechanism 65 to slide the observation optical system 9 and the analysis optical system 7 integrally, so that the switching from the second mode to the first mode is executed.

In the subsequent step S3, the primary storage device 21b as the storage section reads the substance library Li from the secondary storage device 21c or the like. This step S3 is an example of the “reading step” in the present embodiment. Further, step S3 as the reading step may be executed in the middle of processing step S4. The reading step S3 may be performed at least earlier than step S43 among steps S41 to S46 to be described later.

After the mode switching is completed, the component analysis of the sample SP is performed by the spectrum acquirer 212, the characteristic extractor 213, and the substance estimator 214 in the subsequent step S4. Further, the control of the display 22 by the UI controller 215 is also executed in this step S4. Step S4 is an example of a “processing step” in the present embodiment. Specifically, processing performed in step S4, which is the processing step, includes steps S41 to S46 in FIG. 15.

First, in step S41, the spectrum acquirer 212 causes the emitter 71 to emit laser light, and causes the first and second detectors 77A and 77B to receive plasma light generated by the emission. The first and second detectors 77A and 77B generate an intensity distribution spectrum which is an intensity distribution for each wavelength of the plasma light. The intensity distribution spectrum generated by the first and second detectors 77A and 77B is acquired by the spectrum acquirer 212. Step S41 is an example of an “acquisition step” in the present embodiment.

In the subsequent step S42, the characteristic extractor 213 extracts the characteristic Ch of a substance contained in the sample SP based on the intensity distribution spectrum acquired by the spectrum acquirer 212. In this example, the characteristic extractor 213 extract a constituent element of the sample SP and a content of the constituent element as the characteristic Ch of the substance. This extraction may be performed based on various physical models, may be performed through a calibration curve graph, or may be performed using a statistical method such as multiple regression analysis. Step S42 is an example of an “extraction step” in the present embodiment.

In the subsequent step S43, the substance estimator 214 estimates a type of the substance contained in the sample SP (particularly, the type of the substance irradiated with the laser light) based on the characteristic Ch of the substance extracted by the characteristic extractor 213. This estimation can be performed by the substance estimator 214 collating the characteristic Ch of the substance with the substance library Li. At that time, two or more of the subclasses C3 are estimated in descending order of the accuracy based on the accuracy (similarity degree) of each of the types of the substances classified as the subclass C3 in the substance library Li and the contents of the constituent elements extracted by the characteristic extractor 213. Step S43 is an example of an “estimation and identification step” in the present embodiment.

In a subsequent step S44, the substance estimator 214 searches for the intermediate class C2 and superclass C1 corresponding to each of the subclasses C3 identified in step S43. The substance estimator 214 collects the respective subclasses C3 to be searched and the searched intermediate classes C2 and superclasses C1 as one set, and sets data that needs to be displayed on the display 22 out of a hierarchical structure stored in the substance library Li.

In the subsequent step S45, the UI controller 215 reads the supplementary descriptions D1, D2, and D3 associated with the respective classes for each of the subclasses C3, the intermediate classes C2, and the superclasses C1 grouped in one set in step S44. The UI controller 215 combines the read supplementary descriptions D1 to D3 to create text data that needs to be displayed on the display 22. Note that, when the supplementary description D3 associated with the subclass C3 is blank (when the supplementary description D3 has not been set), the UI controller 215 combines only the supplementary description D2 associated with the intermediate class C2 and the supplementary description D1 associated with the superclass C1 to create text data. If the supplementary description D2 associated with the intermediate class C2 is also blank, the UI controller 215 generates text data using only the supplementary description D1 associated with the superclass C1.

In the subsequent step S46, the UI controller 215 displays various types of data on the display 22. Step S46 is an example of a “display step” in the present embodiment. In this step S46, not only the hierarchical structure set in step S44 but also various user interfaces, such as an icon for receiving the user's operation input, are displayed on the display 22. Hereinafter, the user interfaces to be displayed on the display 22 will be described with reference to FIGS. 16A to 16H.

-Specific Examples of User Interface-

FIGS. 16A to 16H are views illustrating display screens of the display 22. At a timing immediately after step S45 to step S46, the UI controller 215 causes the display 22 to display the first information Vd1 indicating the characteristic Ch extracted by the characteristic extractor 213, second information Vd2 indicating the type of the substance estimated by the substance estimator 214, and third information Vd3 indicating the hierarchical structure of the estimated substance as illustrated in FIG. 16A.

In the example illustrated in FIG. 16A, the fact that the sample SP contains iron, chromium, and nickel and numerical data indicating that a content of iron is 74%, and a content of chromium is 17%, and a content of nickel is 9% are displayed as the first information Vd1. Here, a first icon Ic1 that receives a click operation or the like by the mouse 31 is displayed below the first information Vd1. Although details are omitted, the setting related to the processing performed by the characteristic extractor 213 can be changed by clicking the first icon Ic1 with a note “detection setting . . . ”.

Further, a second icon Ic2 that receives a click operation or the like by the mouse 31 is displayed further below the first icon Ic1. As illustrated in FIG. 16B, the fourth information Vd4 indicating an intensity distribution spectrum acquired by the spectrum acquirer 212 and the characteristic Ch extracted from the intensity distribution spectrum can be displayed on the display 22 by operating the second icon Ic2 with a note “spectrum”. In the example illustrated in the drawing, it can be seen that the intensity distribution spectrum have peaks at a wavelength λ1 corresponding to iron, a wavelength λ2 corresponding to chromium, and a wavelength λ3 corresponding to nickel, respectively.

Returning to FIG. 16A, the fact that the superclass C1 of the substance is “stainless steel” is displayed, as the second information Vd2, on the left side of the first information Vd1. Further, as the third information Vd3, the intermediate classes C2 belonging to the superclass C1 are displayed in the order of “austenitic”, “precipitation hardening” and “austenitic” below the second information Vd2. This order is equal to the order of accuracy of the subclass C3 corresponding to each of the intermediate classes C2. In this example, it is suggested that “austenitic” as the intermediate class C2 includes both the subclass C3 that is more accurate than the subclass C3 that belongs to “precipitation hardening” and the subclass C3 that is less accurate than the subclass C3 that belongs to “precipitation hardening”. In the example illustrated in the drawing, subclass C3 with a relatively high accuracy includes SUS302 and the like, the subclass C3 with a medium accuracy includes SUS631 and the like, and subclass C3 with a relatively low accuracy includes SUS304, SUS321, SUS305, and the like (not illustrated).

Here, a fifth icon Ic5 displayed on the left side of the intermediate class C2 such as “austenitic” may be first clicked in order to know details of the subclass C3. The fifth icon Ic5 is an icon for switching the display and non-display of a “second intermediate class” belonging to the intermediate class C2 and to which the subclass C3 belongs, and is displayed on the display 22, particularly in a display column of the third information Vd3 by the UI controller 215. The fifth icon Ic5 is an example of a “second icon” in the present embodiment.

The second intermediate class is a class obtained by subdividing the intermediate class C2. When this second intermediate class is further subdivided, the subclasses C3 in this example can be obtained. Note that the second intermediate class is not essential. Further, a third intermediate class belonging to the second intermediate class may be set, or an additional intermediate class belonging to the third intermediate class may be set. The subclass C3 may be associated with the lowest layer of the intermediate class set in this manner. Note that the intermediate class, the second intermediate class, the third intermediate class, and the additional intermediate class may be set only for some of the subclasses C3. The presence or absence of the intermediate class to which the subclass C3 belongs and the number of intermediate classes to be subdivided may be different depending on the subclass C3. That is, when SUS300, SUS301, and SUS303Se are set as the subclasses C3, the intermediate class C2 called “austenitic” may be set for the subclasses C3 called SUS300 and SUS301, and a second intermediate class called “SUS303 series” as well as the intermediate class C2 called “austenitic” may be set for SUS303Se. Since the presence or absence of the intermediate class to which the subclass C3 belongs and the number of intermediate classes to be subdivided are made different depending on a property or the like of the subclass C3 in this manner, it is possible to more appropriately notify the user of a strain and a general term of the class to which the sample SP as the analyte belongs.

Here, when the fifth icon Icy located on the left side of the “austenitic” arranged at the top in FIG. 16A is operated, the second intermediate class belonging to “austenitic” can be displayed in the display 22, particularly in the display column of the third information Vd3 as illustrated in FIG. 16C. In this example, “SUS300 series” is displayed as the second intermediate class. Further, when the superclass C1 is expanded to the intermediate class C2 and the second intermediate class, the display of the second information Vd2 also changes as illustrated in FIG. 16C. In the example illustrated in the drawing, the fact that “austenitic” as the intermediate class C2 belongs to “stainless steel” as the superclass C1, and the fact that “SUS300 series” as the second intermediate class belongs to “austenitic” as the intermediate class C2 are displayed on the display 22 as the second information Vd. Note that the above-described identification information may be displayed in various display fields as a class higher than the superclass C1 as illustrated in FIG. 16C. In the example illustrated in the drawing, the identification information is illustrated above the second information Vd2 as the “used library”, but the identification information may be incorporated in a display field of the third information Vd3. The identification information can be used as a top-level class higher than the superclass C1.

Then, a sixth icon Ic6 is further displayed on the left side of the second intermediate class displayed as “SUS300 series”. The sixth icon Ic6 is an icon for switching between display and non-display of the subclass C3 belonging to the second intermediate class, and is displayed on the display 22 by the UI controller 215.

When the sixth icon Ic6 is operated, the subclass C3 belonging to the “SUS300 series” can be displayed in the display 22, particularly in the display column of the third information Vd3 as illustrated in FIG. 16D. Specifically, the UI controller 215 according to the present embodiment can display the superclass C1, the intermediate class C2, and the second intermediate class to which the subclass C3 belongs as well as the subclass C3 displayed when the sixth icon Ic6 is operated, on the display 22, particularly, in the display field of the third information Vd3 as illustrated in FIG. 16D. Further, details of the superclass C1 and the like to which the subclass C3 belongs are also reflected in a display content of the second information Vd2 as illustrated in the same drawing. In the example illustrated in the drawing, “SUS302” having a relatively high accuracy and “SUS303Se” having a relatively low accuracy are displayed as the subclasses C3.

Further, a third icon Ic3 that receives a click operation by the mouse 31 is displayed below the third information Vd3. When the third icon Ic3 with a note “descriptive text display” is operated, the text data created in step S45 described above can be displayed on the display 22.

Here, FIG. 16E illustrates the display screen when the third icon Ic3 is operated from the state illustrated in FIG. 16C (the state where the subclass C3 is not displayed). FIG. 16F illustrates the display screen when the third icon Ic3 is operated from the state illustrated in FIG. 16D (the state where the subclass C3 is displayed). The respective display screens illustrates a fifth information Vd5 indicating the text data obtained by combining the supplementary descriptions D1 to D3 of the respective classes.

Here, for example, when the supplementary description D3 associated with the subclass C3 is blank as described with reference to FIG. 13B, the display screen when the operation of the third icon Ic3 is received from the state where the subclass C3 is not displayed and the display screen when the operation of the third icon Ic3 is received from the state where the subclass C3 is displayed are the same except for the second information Vd as illustrated in FIGS. 16E and 16F. In this case, the text data obtained by combining the supplementary description D1 associated to the superclass C1, the supplementary description D2 associated to the intermediate class C2, and the supplementary description associated to the second intermediate class is displayed as the fifth information Vd5 on the display 22. On the other hand, when the supplementary description D3 associated to the subclass C3 has been set, the supplementary description associated to the subclass C3 is also displayed on the display screen when the fifth information Vd5 is displayed from the state where the subclass C3 is displayed.

Further, a fourth icon Ic4 that receives a click operation by the mouse 31 is displayed on the right side of the third icon Ic3. When receiving the operation of the fourth icon Ic4, the UI controller 215 switches a display content of the display 22 from the display screen illustrated in FIGS. 16A or 16B to 16F to the display screen illustrated in FIG. 16G.

Specifically, when receiving the operation of the fourth icon Ic4, the UI controller 215 causes the display 22 to display sixth information Vd6 indicating an interface for selecting a classification standard of the superclass C1 to the subclass C3. In this sixth information Vd6, a plurality of seventh icons Ic7 configured to select “JIS”, “ISO”, “EN”, “ANSI”, and “user-defined” exemplifying the first or second standard are displayed.

For example, if the seventh icon Ic7 arranged on the left side of a note “JIS” is clicked, “JIS” is selected as the first standard, whereby processing using the first substance library Li1 generated according to “JIS” is performed. In this case, the identification information indicating that “JIS” is selected can be superimposed and displayed on the fourth icon Ic4 as illustrated in FIG. 16A and the like.

Further, when the seventh icon Ic7 arranged on the left side of a note “user-defined” is clicked, a standard uniquely defined by the user is selected, whereby processing using the user-defined library set by the user is performed. The user-defined library can be set, for example, by operating an eighth icon Ic8 with a note “edit” (whose details are omitted). Further, an operation status of the seventh icon Ic7 and the setting of the user-defined library are stored by operating a ninth icon Ic9 with a note “store”. When a tenth icon Ic10 with a note “back” is clicked, the UI controller 215 switches the display content of the display 22 from the display screen illustrated in FIG. 16G to the display screen illustrated in FIGS. 16A or 16B to 16F.

Note that it is also possible to select two or more standards by operating two or more of the plurality of seventh icons Ic7 in the sixth information Vd6. For example, when “ISO” is also selected as the second standard in addition to “JIS” as the first standard, processing using both the first substance library Li1 generated according to “JIS” and the second substance library Li2 generated according to “ISO” is performed. In this case, the identification information D5 of “JIS+ISO” indicating that both “JIS” and “ISO” are selected can be superimposed and displayed on the fourth icon Ic4 as illustrated in FIG. 16H. Further, in this case, not only “stainless steel”, which is the superclass C1 based on “JIS” but also a class of “ISO/TS 15510”, which is the superclass C1 based on “ISO” is also simultaneously displayed in the third information Vd3. The order of these superclasses C1 may be set in the descending order of the accuracy. Further, when the user-defined library is selected, the UI controller 215 can display information indicating that the standard uniquely defined by the user, such as “user-defined”, is selected as the identification information D5 to be superimpose on the fourth icon Ic4. Note that, in response to switching of the selection of the seventh icon Ic7, the substance estimator 214 may re-estimate the subclass C3 corresponding to the characteristic Ch of the substance from among the subclasses C3 belonging to the selected standard, and update the information displayed in the third information Vd3 with the re-estimated content.

<Intuitive Grasp of Substance>

As described above, the subclass C3 is displayed together with the superclass C1 on the display 22 according to the present embodiment as illustrated in the output D4 of FIG. 13B and the third information Vd3 of FIG. 16D. Thus, not only a specific type of a substance can be grasped with the subclass C3, but also a general type, a property, a characteristic, and the like of the substance can be grasped through the superclass C1. As a result, the user can intuitively grasp what kind of substance the sample SP is.

Further, since the sixth icon Ic6 configured to switch between the display and non-display of the subclass C3 is used as illustrated in FIG. 16D, it is possible to provide an interface that can be operated more intuitively. Further, the subclasses C3 are arranged in order of the accuracy as illustrated in “SUS302” and “SUS303Se”, and thus, the user can intuitively grasp any of the subclasses C3 to which a substance type belongs.

Further, the intermediate class C2 is prepared in addition to the superclass C1 and the subclass C3 as illustrated in FIGS. 13A, 13B, 16A, and the like, and thus, the substances can be classified more finely. Further, the non-display of the intermediate class C2 is performed by operating the fifth icon Icy for users who do not want such detailed classification, and thus, it is possible to provide an interface that can be operated more intuitively and to improve the usability.

Further, since the plurality of substance libraries Li1 and Li2 are prepared as illustrated in FIGS. 13A, 13B, 16G and 16H, a more flexible classification system can be provided. Further, even when standards used as practices are different due to differences in industry or culture, it is possible to use a library suitable for a user and to meet a wide variety of needs. Further, since the identification information D5 is displayed on the display 22 to be superimposed and displayed on the fourth icon Ic4 or the like, the user can easily grasp any of the substance libraries Li that has been used as a base of the classification system. As a result, it is possible to help the user's intuitive understanding.

Further, since the user-defined substance library is prepared in addition to the predetermined substance libraries Li1 and Li2, it is possible to provide a more flexible classification system and to meet a wide range of needs.

Further, the display 22 displays the supplementary description D1 associated with the selected superclass C1 or the superclass C1 to which the selected subclass C3 belongs as illustrated in FIGS. 13B, 16E and 16F. Thus, the user can grasp the information related to the superclass C1, such as the general type, the property, and the characteristic of the substance. As a result, there is an advantage in terms of allowing the user to grasp what kind of substance the sample SP is.

What is claimed is:

1. An analysis device that emits a primary electromagnetic wave or a primary ray to an analyte to generate an intensity distribution spectrum and performs component analysis of the analyte based on the intensity distribution spectrum, the analysis device comprising:
a storage that read outs a substance library in which each of types of substances is associated with characteristic of the substance; and
a processor that executes processing based on the substance library,
wherein
the substance library is configured by storing hierarchical information of
superclasses each of which represents a general term of the substance and
subclasses respectively representing types of a plurality of the substances belonging to the superclass, and
the processor includes:
a spectrum acquirer that acquires the intensity distribution spectrum;
a characteristic extractor that extracts a characteristic included as a constituent component in the analyte based on the intensity distribution spectrum acquired by the spectrum acquirer;
a substance estimator that estimates the type of the substance from the subclasses based on the characteristic extracted by the characteristic extractor and the substance library read out by the storage; and
a user interface controller that causes a display to display the type of the substance estimated from the subclasses by the substance estimator and the superclass to which the type of the substance belongs in a hierarchical manner.

2. The analysis device according to claim 1, wherein
the substance estimator estimates a plurality of substances each having a relatively high accuracy among substances that are likely to be contained in the analyte from the subclasses, and
the user interface controller causes the display to display
the subclasses respectively corresponding to the plurality of substances arranged in descending order of the accuracy,
an icon for switching between display and non-display of the subclasses, and
the superclass to which the subclass belongs.

3. The analysis device according to claim 2, wherein
the substance library is configured by storing hierarchical information of intermediate classes which represent a plurality of strains belonging to the superclass and to which at least some of the subclasses belong together with the hierarchical information of the superclass and the subclass, and
the user interface controller causes the display to display
the intermediate class to which the subclass belongs and
a second icon for switching between display and non-display of the intermediate class.

4. The analysis device according to claim 2, wherein
the storage section read outs, as the substance library,
a first substance library created according to a first standard and
a second substance library created according to a second standard,
the substance estimator estimates a plurality of substances each having a relatively high accuracy among substances that are likely to be contained in the analyte from the subclasses belonging to the first substance library and the subclasses belonging to the second substance library, and
the user interface controller causes the display to display the subclasses estimated by the substance estimator together with identification information indicating any of the first substance library and the second substance library to which the subclasses belongs to.

5. The analysis device according to claim 1, wherein
the storage section reads, as the substance library,
a first substance library created according to a first standard and
a user-defined substance library created based on an operation input of a user,
the substance estimator estimates a plurality of substances each having a relatively high accuracy among substances that are likely to be contained in the analyte from the subclasses belonging to the first substance library and the subclasses belonging to the user-defined substance library, and
the user interface controller causes the display to display the subclasses estimated by the substance estimator together with identification information indicating any of the first substance library and the user defined substance library to which the subclasses belongs to.

6. The analysis device according to claim 1, wherein
the substance library is configured by storing the superclass and a supplementary description related to the general term of the substance represented by the superclass in association with each other, and
the user interface controller receives selection of one of the superclasses displayed on the display, and causes the display to display the supplementary description associated with the selected superclass.

7. The analysis device according to claim 6, wherein
the user interface controller receives selection of one of the subclasses displayed on the display, and causes the display to display the supplementary description associated with the superclass to which the selected subclass belongs.

8. The analysis device according to claim 1, further comprising:
an emitter that emits a primary electromagnetic wave or a primary ray to the analyte; and
a detector that receives a secondary electromagnetic wave generated in the analyte when the analyte is irradiated with the primary electromagnetic wave or the primary ray and generates an intensity distribution spectrum which is an intensity distribution for each wavelength of the secondary electromagnetic wave,
wherein the spectrum acquirer acquires the intensity distribution spectrum generated by the detector.

9. The analysis device according to claim 1, wherein
the characteristic extractor extracts, as the characteristic of the substance, a type of an element contained in the substance and a content rate of the element.

10. The analysis device according to claim 1, wherein
the characteristic extractor extracts, as the characteristic of the substance, a molecular structure in the substance.

11. An analysis method for generating an intensity distribution spectrum by emitting a primary electromagnetic wave or a primary ray to an analyte and performing component analysis of the analyte based on the intensity distribution spectrum using an analysis device including a storage that stores information and a processor, the analysis method comprising:
a reading step of reading out, by the storage a substance library in which each of types of substances is associated with a characteristic of the substance; and
a processing step of executing, by the processor, processing based on the substance library,
wherein
the substance library is configured by storing hierarchical information of
superclasses each of which represents a general term of the substance and
subclasses respectively representing types of a plurality of the substances belonging to the superclass, and
the processing step includes:
an acquisition step of acquiring the intensity distribution spectrum;
an extraction step of extracting characteristics included in the analyte as constituent components of the analyte based on the intensity distribution spectrum acquired in the acquisition step;
an estimation step of estimating the type of the substance from the subclasses based on the characteristic extracted in the extraction step and the substance library read out in the reading step; and
a display step of causing a display to display the type of the substance estimated from the subclasses in the estimation step and the superclass to which the type of the substances belongs in a hierarchical manner.
